(19) United States
(12) Patent Application Publication
(10) Pub. No.: US 2011/0169811 A1
(43) Pub. Date: Jul. 14, 2011

(54) PLASMA DISPLAY APPARATUS AND METHOD OF DRIVING PLASMA DISPLAY PANEL

(75) Inventor: Toshikazu Nagaki, Osaka (JP)

(73) Assignee: Panasonic Corporation, Osaka (JP)

(21) Appl. No.: 12/666,182

(22) PCT Filed: Apr. 15, 2009
(86) PCT No.: PCT/JP2009/001733

§ 371 Date: Jul. 13, 2010

(30) Foreign Application Priority Data
Apr. 22, 2008 (JP) 2008-111328

(51) Int. Cl. G09G 3/28; G09G 5/00

(52) U.S. Cl. 345/212; 345/60

(57) ABSTRACT

A sustain pulse generating circuit has a power recovery circuit and an auxiliary circuit. The power recovery circuit has an inductor with a first coil, a second coil, and a third coil, and a capacitor. The auxiliary circuit has a first auxiliary switch and a second auxiliary switch. The sustain pulse generating circuit energizes the first auxiliary switch and stores energy in a forward direction to the first coil immediately before the sustain pulse rise. Immediately before the sustain pulse falls, the sustain pulse generating circuit energizes the second auxiliary switch and stores energy in a reverse direction to the second coil. When the sustain pulse rises and falls, the current flowing between the power recovery circuit and the capacitive load is the current produced by LC resonance plus the current produced by the energy previously stored in the recovery inductor.

### BACKGROUND OF THE INVENTION

1. Field of Invention

The present invention relates to driving a capacitive load, and relates more particularly to plasma display devices used in wall-mounted televisions and large-scale monitors, and to a method of driving such plasma display panels.

2. Description of Related Art

An AC surface discharge panel typical of a plasma display panel (PDP, also referred to as simply “panel” herein) has numerous discharge cells formed between opposing front and back plates. The front plate has a plurality of display electrode pairs each including a scan electrode and a sustain electrode formed parallel to each other on a front glass substrate with a dielectric layer and a protective layer formed thereon so as to cover the display electrode pairs. The back plate has a plurality of parallel data electrodes formed on a back glass substrate, a dielectric layer covering the data electrodes, and a plurality of barrier ribs formed on the dielectric layer parallel to the data electrodes, and a phosphor layer is formed on the surface of the dielectric layer and the sides of the barrier ribs. The front and back plates are assembled and sealed so that the display electrodes and data electrodes intersect three-dimensionally, and the resulting internal discharge space is filled with a discharge gas containing xenon at a 5% partial pressure, for example. Discharge cells are formed in the parts where the display electrode pairs are opposite the data electrodes. Panels thus configured produce ultraviolet light by gas discharge in each discharge cell, and produce a full color display by using the UV light to excite red (R), green (G), and blue (B) phosphors.

The panel is generally driven using a subfield method, that is, a method of displaying color gradations by dividing one field period into a plurality of subfields and controlling the combination of subfields that are driven to emit.

Each subfield has an initialization period, an address period, and a sustain period. A priming discharge is produced in the initialization period in order to form the wall charge required in the following address operation on each electrode, and to produce priming particles (a discharge initiator or excited particles) in order to produce a stable address discharge.

In the address period, an address pulse voltage is selectively applied to the discharge cells that are to display, producing an address discharge and forming a wall charge (this operation is also referred to as “writing” below).

In the sustain period, a sustain pulse voltage is applied alternately to the display electrode pairs each composed of a scan electrode and a sustain electrode, producing a sustain discharge in the discharge cells in which an address discharge was produced, and thereby causing the phosphor layers of the corresponding discharge cells to emit and display an image.

Various power consumption reduction technologies have been proposed for reducing power consumption in plasma display devices that use this type of panel. U.S. Pat. No. 4,866,349 (corresponding to Japanese Laid-open Patent Publication No. S63-101897), for example, teaches a power recovery circuit for reducing power consumption in the sustain period by focusing on each of the display electrodes being a capacitive load with capacitance between the electrodes of the display electrode pair. This method uses a resonance circuit that includes an inductor, produces LC resonance in the inductor and interelectrode capacitance, recovers the charge accumulated in the interelectrode capacitance in a power recovery capacitor, and then reuses the recovered charge to drive the display electrode pair.

Japanese Laid-open Patent Publication No. 2006-10750 teaches technology for reducing the switching loss that accompanies power recovery using an auxiliary resonance unit and thereby improves recovery efficiency.

U.S. Patent Application Publication No. 2005/0200562 A1 (corresponding to Japanese Laid-open Patent Publication No. 2005-49814) teaches technology for achieving a stable discharge across the entire panel, and reducing the switching loss that occurs when switching from the power recovery circuit to a clamping circuit, and from the clamping circuit to the power recovery circuit.

As panel definition has increased, the number of electrodes that must be addressed in one subfield period has increased, and this increases the time required for one address period. This therefore requires a corresponding countermeasure such as shortening the sustain pulse period and shortening the sustain period.

However, in order to produce a stable sustain discharge, the period (clamping period) for which the sustain pulse is held at the power supply voltage must be sufficiently long. In order to maintain a sufficient clamping period while also shortening the sustain pulse period, it is necessary to, for example, produce sustain pulses with sharp rising and falling edges to shorten the time spent on each pulse.

If the LC resonance period of the power recovery circuit is shortened in order to render the sustain pulses with a sharp rising and falling edge characteristic, the maximum current flowing when the electrodes are driven (also called the “peak current” below) rises. In addition to increasing the amount of power that is consumed reactively without contributing to discharge cell emissions (“reactive power”), this increased current also increases electromagnetic interference (EMI).

The rise of the sustain pulse can be more gradual, reactive power can be reduced by suppressing peak current, and EMI can be reduced by increasing the LC resonance period, but the sustain pulse period increases according to the decreased slope of the sustain pulse rise, and the sustain period thus becomes longer.

Power consumption increases further as the display size increases and brightness increases, and because the number of electrodes that must be driven increases as panel definition increases, power consumption rises even more.

### SUMMARY OF THE INVENTION

The present invention is directed to the foregoing problems, and an object of the invention is to provide a plasma display device that can reduce power consumption and achieve a stable sustain discharge even in a high definition panel, and a drive method for the plasma display panel.

A first aspect of the invention is a plasma display device having a sustain pulse generating circuit that alternately applies sustain pulses in a sustain period of a subfield having an initialization period, an address period, and the sustain period to display electrode pairs of a plasma display panel that has a plurality of scan electrodes and sustain electrodes forming the display electrode pairs. The sustain pulse generating circuit includes a power recovery circuit that has a recovery inductor for LC resonance having at least two coils, and a recovery capacitor for power recovery, recovers power stored in a capacitive load of the display electrode pairs to the recovery capacitor by LC resonance, and reuses the recovered power to drive the display electrode pairs, a clamping circuit that clamps the display electrode pairs to a power supply potential and a ground potential, and an auxiliary circuit that has a first auxiliary switch and a second auxiliary switch. The auxiliary circuit is configured to store energy in a forward direction to the recovery inductor when the first auxiliary switch is energized and to store energy in a reverse direction to the recovery inductor when the second auxiliary switch is energized, energizes the first auxiliary switch and stores energy in the forward direction to the recovery inductor immediately before the sustain pulse rises, and energizes the second auxiliary switch and stores energy in the reverse direction to the recovery inductor immediately before the sustain pulse falls. The power recovery circuit adds current produced by the energy previously stored in the recovery inductor to current produced by the LC resonance to produce the current that flows between the power recovery circuit and the capacitive load when the sustain pulse rises and falls.

This aspect of the invention adds current produced by the energy stored in a recovery inductor to the current that flows between the power recovery circuit and the capacitive load of the display electrode pairs when the sustain pulse rises and falls, and as a result can increase the LC resonance period (referred to below as simply the “resonance period”) of the recovery inductor and the capacitive load, reduce the peak current, reduce power consumption, and reduce EMI. Furthermore, because current flows only through the minimum required circuitry when storing energy in the recovery inductor, power consumption can be reduced and unnecessary heat output can be prevented.

In the plasma display device according to another aspect of the invention, the first auxiliary switch of the auxiliary circuit passes current through a first coil of the recovery inductor, and the second auxiliary switch of the auxiliary circuit passes current through a second coil of the recovery inductor, and the auxiliary circuit is configured so that current is produced flowing from the recovery capacitor through the first coil of the recovery inductor to the reference potential when the first auxiliary switch is energized, and current is produced flowing from the recovery capacitor through the second coil of the recovery inductor to the reference potential when the second auxiliary switch is energized.

As a result, current flowing from the recovery capacitor through the first coil of the recovery inductor to the reference potential can be produced when the first auxiliary switch is energized, current flowing from the recovery capacitor through the second coil of the recovery inductor to the reference potential can be produced when the second auxiliary switch is energized, and energy can be stored in the reverse direction to the recovery inductor.

In the plasma display device according to another aspect of the invention, the first auxiliary switch and the second auxiliary switch of the auxiliary circuit each have a pair of switches, and the auxiliary circuit is configured so that current flowing from the recovery capacitor through the first coil of the recovery inductor to the reference potential is produced when the pair of first auxiliary switches is energized, and current flowing through the first coil of the recovery inductor to the reference potential in the reverse direction as the current that flows from the recovery capacitor when the pair of first auxiliary switches is energized is produced when the pair of second auxiliary switches is energized.

As a result, the first coil of the recovery inductor storing energy forward can be used as a coil operable to store energy in the reverse direction.

In the plasma display device according to another aspect of the invention, the recovery inductor of the power recovery circuit has an inductor operable to flow current in the forward direction to store energy in the forward direction, and an inductor operable to flow current in the reverse direction to store energy in the reverse direction.

As a result, the energy that is stored forward and the energy that is stored in reverse can be adjusted independently of each other.

In the plasma display device according to another aspect of the invention, the sustain pulse generating circuit is configured so that current flows through a first coil of the recovery inductor when the first auxiliary switch and a ground potential side switch of the clamping circuit are energized, and current flows through a second coil of the recovery inductor when the second auxiliary switch and a power supply potential side switch of the clamping circuit are energized.

As a result, the current that is supplied when energy is stored forward and when energy is stored in reverse to the recovery inductor can be made to increase rapidly, and the time needed to store energy can be shortened.

In the plasma display device according to another aspect of the invention, the auxiliary circuit varies the power supply potential and reference potential used in the auxiliary circuit according to the display image.

As a result, the energy stored in the recovery inductor in a predetermined period can be changed according to the display image. For example, by storing more energy in the recovery inductor when the display image is bright than when the display image is dark, the rise in the sustain pulse when the display image is bright can be made faster than the rise of the sustain pulse when the display image is dark, and stable drive is possible.

In the plasma display device according to another aspect of the invention, the auxiliary circuit varies the energizing period of the first auxiliary switch and second auxiliary switch according to the display image.

This aspect of the invention can also change how much energy is stored in the recovery inductor according to the display image, and thus enables stable display panel drive.

Another aspect of the invention is a plasma display device having a sustain pulse generating circuit that alternately applies sustain pulses in a sustain period of a subfield having an initialization period, an address period, and the sustain period to display electrode pairs of a plasma display panel that has a plurality of scan electrodes and sustain electrodes forming the display electrode pairs. The sustain pulse generating circuit includes a power recovery circuit that has a recovery inductor for LC resonance having at least three coils, and a recovery capacitor for power recovery, recovers power stored in a capacitive load of the display electrode pairs to the recovery capacitor by LC resonance, and reuses the recovered power to drive the display electrode pairs, a clamping circuit that clamps the display electrode pairs to a power supply potential and a ground potential, and an auxiliary circuit that has an auxiliary switch. The auxiliary circuit is configured to store energy in a reverse direction to the recovery inductor when the auxiliary switch is energized, and energizes the auxiliary switch and stores energy in the reverse direction to the recovery inductor immediately before the sustain pulse falls. The power recovery circuit adds current produced by the energy previously stored in the recovery inductor to current produced by the LC resonance to produce the current that flows between the power recovery circuit and the capacitive load when the sustain pulse rises and falls.

In the plasma display device according to another aspect of the invention, the sustain pulse generating circuit preferably has a scan electrode sustain pulse generating circuit and a sustain electrode sustain pulse generating circuit, and the scan electrode sustain pulse generating circuit shares the recovery inductor for LC resonance and recovery capacitor of the power recovery circuit with the sustain electrode sustain pulse generating circuit.

Further preferably in the plasma display device according to another aspect of the invention, a first coil of the recovery inductor of the power recovery circuit is connected to the auxiliary switch of the auxiliary circuit, the second coil of the recovery inductor is configured as a recovery inductor of the scan electrode sustain pulse generating circuit, and the third coil of the recovery inductor is configured as a recovery inductor of the sustain electrode sustain pulse generating circuit.

Another aspect of the invention is a plasma display panel drive method for a panel for driving a panel that has a plurality of scan electrodes and sustain electrodes forming display electrode pairs, and uses a power recovery circuit that has a recovery inductor for LC resonance having at least two coils, and a recovery capacitor for power recovery, recovers power stored in a capacitive load of the display electrode pairs to the recovery capacitor by LC resonance, and reuses the recovered power to drive the display electrode pairs, a clamping circuit that clamps the display electrode pairs to a power supply potential and a ground potential, and an auxiliary circuit that has a first auxiliary switch and a second auxiliary switch, to produce and alternately apply sustain pulses to the display electrode pairs in sustain periods of a plurality of subfields having initialization periods, address periods, and the sustain periods. The plasma display panel drive method includes storing energy in a forward direction to the recovery inductor when the first auxiliary switch of the auxiliary circuit is energized and storing energy in a reverse direction to the recovery inductor when the second auxiliary switch of the auxiliary circuit is energized; energizing the first auxiliary switch and storing energy in the forward direction to the recovery inductor immediately before the sustain pulse rises, and energizing the second auxiliary switch and storing energy in the reverse direction to the recovery inductor immediately before the sustain pulse falls; and adding current produced by the energy previously stored in the recovery inductor to current produced by the LC resonance to produce the current that flows between the power recovery circuit and the capacitive load when the sustain pulse rises and falls.

This aspect of the invention adds current produced by the energy stored in a recovery inductor to the current that flows between the power recovery circuit and the capacitive load of the display electrode pairs when the sustain pulse rises and falls, and as a result can increase the resonance period of the recovery inductor and the capacitive load, reduce the peak current, reduce power consumption, and reduce EMI. Furthermore, because current flows only through the minimum required circuitry when storing energy in the recovery inductor, power consumption can be reduced and unnecessary heat output can be prevented.

The plasma display panel drive method according to another aspect of the invention includes producing current flowing from the recovery capacitor through the first coil of the recovery inductor to the reference potential when the first auxiliary switch is energized, and producing current flowing from the recovery capacitor through the second coil of the recovery inductor to the reference potential when the second auxiliary switch is energized.

As a result, current flowing from the recovery capacitor through the first coil of the recovery inductor to the reference potential can be produced when the first auxiliary switch is energized, current flowing from the recovery capacitor through the second coil of the recovery inductor to the reference potential can be produced when the second auxiliary switch is energized, and energy can be stored in the reverse direction to the recovery inductor.

The plasma display panel drive method according to another aspect of the invention preferably includes controlling the power supply potential and reference potential used in the auxiliary circuit according to the display image.

Because the energy stored in the recovery inductor in a predetermined period can thus be controlled according to the display image, the amount of energy stored in the recovery inductor can be changed when the display image is bright and when the display image is dark, the rise in the sustain pulse can therefore be changed, and stable drive is possible.

The plasma display panel drive method according to another aspect of the invention preferably includes controlling the period that the first auxiliary switch is energized to store energy in the forward direction to the recovery inductor, and the period that the second auxiliary switch is energized to store energy in the reverse direction to the recovery inductor, according to the display image.

This method can also change the energy stored in the recovery inductor according to the display image, and stable drive is thus possible.

Another aspect of the invention is a plasma display panel drive method for driving a plasma display panel that has a plurality of scan electrodes and sustain electrodes forming display electrode pairs by using a power recovery circuit that has a recovery inductor for LC resonance having at least three coils, and a recovery capacitor for power recovery, recovers power stored in a capacitive load of the display electrode pairs to the recovery capacitor by LC resonance, and reuses the recovered power to drive the display electrode pairs, a clamping circuit that clamps the display electrode pairs to a power supply potential and a ground potential, and an auxiliary circuit that has an auxiliary switch to produce and alternately apply sustain pulses to the display electrode pairs in sustain periods of a plurality of subfields having initialization periods, address periods, and the sustain periods. The plasma display panel drive method includes storing energy in a reverse direction to the recovery inductor when the auxiliary switch of the auxiliary circuit is energized; energizing the auxiliary switch and storing energy in the reverse direction to the recovery inductor immediately before the sustain pulse falls; storing energy in a reverse direction to the recovery inductor when the auxiliary switch of the auxiliary circuit is energized, energizing the auxiliary switch and storing energy in the reverse direction to the recovery inductor immediately before the sustain pulse falls; and adding current produced by the energy previously stored in the recovery inductor to current produced by the LC resonance to produce the current that flows between the power recovery circuit and the capacitive load when the sustain pulse rises and falls.

The plasma display device and the plasma display panel drive method according to the present invention can produce a stable sustain discharge by assuring a sufficient clamping period, and can reduce power consumption and EMI by reducing peak current, even when driving a high definition panel with a shortened sustain pulse period by using an auxiliary circuit to sharpen the edge characteristic of the sustain pulses.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a partially exploded oblique view showing the structure of a panel according to a first embodiment of the invention.

FIG. 2 describes the electrode configuration in a panel according to a first embodiment of the invention.

FIG. 3 is a drive voltage waveform diagram showing the drive voltages applied to the electrodes of a panel according to a first embodiment of the invention.

FIG. 4 is a circuit block diagram of a plasma display device according to a first embodiment of the invention.

FIG. 5 is a circuit block diagram of a sustain pulse generating circuit in a first embodiment of the invention.

FIG. 6 is a circuit diagram of the sustain pulse generating circuit in a first embodiment of the invention.

FIG. 7 is a timing chart describing the operation of the sustain pulse generating circuit in a first embodiment of the invention.

FIG. 8 is a circuit diagram showing another example of a sustain pulse generating circuit according to a second embodiment of the invention.

FIG. 9 is a circuit diagram of the sustain pulse generating circuit in a third embodiment of the invention.

FIG. 10 is a timing chart describing the operation of the sustain pulse generating circuit in a third embodiment of the invention.

FIG. 11 is a circuit diagram of the sustain pulse generating circuit in a fourth embodiment of the invention.

FIG. 12 is a timing chart describing the operation of the sustain pulse generating circuit in a fourth embodiment of the invention.

FIG. 13A is a circuit diagram of the sustain pulse generating circuit in a fifth embodiment of the invention.

FIG. 13B is a circuit diagram of the sustain pulse generating circuit in a fifth embodiment of the invention.

FIG. 13C is a circuit diagram of the sustain pulse generating circuit in a fifth embodiment of the invention.

FIG. 13D is a circuit diagram of the sustain pulse generating circuit in a fifth embodiment of the invention.

FIG. 14 is a timing chart describing the operation of the sustain pulse generating circuit in a fifth embodiment of the invention.

FIG. 15 is a waveform diagram for when the reference potential of an auxiliary circuit is variable in a sixth embodiment of the invention.

FIG. 16 is a waveform diagram when the energizing period of the forward auxiliary switch is variable in a sixth embodiment of the invention.

### DETAILED DESCRIPTION OF THE PREFERRED EMBODIMENTS

Some preferred embodiments of the invention are described below with reference to the accompanying figures wherein parts having effectively the same configuration, operation, and effect are denoted by the same reference numerals or symbols. Numbers used in the following description are shown by way of example only to clearly describe the invention, and the invention is not limited to the numbers in any way. Switching states expressed as on and off are also used by way of example only to describe a specific embodiment of the invention, and it will be obvious that the same effect can be achieved using different combinations of switching states. Connections between specific elements and components are also shown by way of example only, and the connections achieving the function of the invention are not so limited.

### Embodiment 1

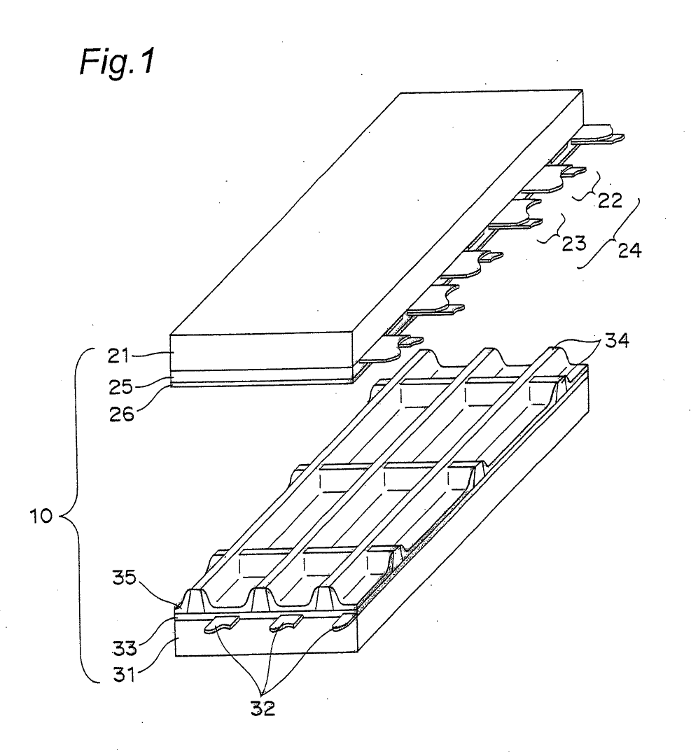

FIG. 1 is a partially exploded oblique view showing the structure of a panel 10 according to a first embodiment of the invention. A plurality of display electrode pairs 24 each composed of a scan electrode 22 and sustain electrode 23 pair are formed parallel to each other on a glass front plate 21. A dielectric layer 25 is formed covering the scan electrodes 22 and sustain electrodes 23, and a protective layer 26 is formed over the dielectric layer 25.

The protective layer 26 is made from a material consisting primarily of MgO (magnesium oxide). MgO has been proven for use as a panel material that lowers the discharge start voltage in the discharge cells, has a high secondary electron emission coefficient when the cells are filled with neon (Ne) and xenon (Xe), and has excellent durability.

A plurality of data electrodes 32 are formed parallel to each other on a back plate 31, a dielectric layer 33 is formed covering the data electrodes 32, and barrier ribs 34 are formed thereon in a grid-like pattern of wells. A phosphor layer 35 that emits red (R), green (G), and blue (B) is disposed on the sides of the barrier ribs 34 and the top of the dielectric layer 33.

The front plate 21 and back plate 31 are then placed together so that the display electrode pairs 24 and data electrodes 32 intersect three-dimensionally across small discharge spaces, and the perimeter is then sealed with glass frit or other sealing material. A discharge gas of neon and xenon is then injected to the internal discharge space. In a preferred embodiment of the invention a discharge gas with a xenon partial pressure of approximately 10% is used to improve emission efficiency. The discharge space is segmented into a plurality of cells by the barrier ribs 34, and the discharge cells are formed in the parts where the display electrode pairs 24 and data electrodes 32 intersect. Gas discharge in each of the discharge cells produces ultraviolet (UV) light, and color images are displayed by using the UV light to excite the phosphors to emit R, G, and B as needed.

It should be noted that the structure of the panel 10 is not limited to the foregoing. For example, the barrier ribs may be rendered in a striped pattern. The mixture of the discharge gas is also not limited to the values described above, and other mix ratios may be used.

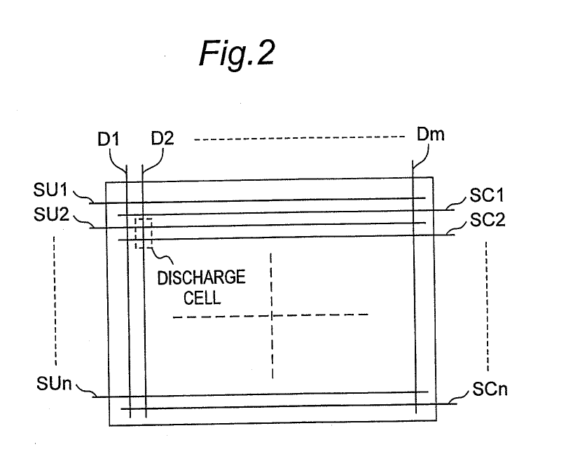

FIG. 2 shows the electrode arrangement of the panel 10. As shown in the figure, n scan electrodes SC1, SC2, . . . , SCn (identical to scan electrodes 22 in FIG. 1, and identified below as scan electrodes SC1 to SCn) and n sustain electrodes SU1, SU2, . . . , SUn (identical to sustain electrodes 23 in FIG. 1, and identified below as sustain electrodes SU1 to SUn) that are long in the row direction, and m data electrodes D1, D2, . . . , Dm (identical to data electrodes 32 in FIG. 1, and identified below as data electrodes D1 to Dm) that are long in the column direction, are formed on the panel 10. A total of m×n discharge cells are thus formed in the discharge spaces where each scan electrode SCi (i=1 to n) and sustain electrode SUi pair intersects with one data electrode Dj (j=1 to m).

The drive voltage waveforms for driving the panel 10 and the operating concept thereof are described next. The plasma display device according to this embodiment of the invention uses the subfield method to display color gradations by dividing one field period into a plurality of subfields and controlling each discharge cell to emit or not emit in each subfield. Each subfield has an initialization period, an address period, and a sustain period.

A priming discharge is produced in the initialization period in order to form the wall charge required for the following address discharge on each electrode. This also works to produce priming particles (discharge initiator or excited particles) for reducing discharge delay and producing a stable address discharge. This initialization operation includes an all-cell initialization operation that produces the priming discharge in all discharge cells, and a selective initialization operation that selectively produces a priming discharge only in the discharge cells in which a sustain discharge was produced in the immediately preceding subfield.

In the address period, an address discharge is selectively produced in the discharge cells that are to emit in the following sustain period, forming a wall charge.

In the sustain period, sustain pulses are alternately applied in a number proportional to the luminance weight to the display electrode pairs 24, causing the discharge cells in which an address discharge was produced to produce a sustain discharge and thus emit. The proportional constant expressing the ratio between the sustain pulse count and the luminance weight is called the “luminance scaling factor.”

One field is composed of ten subfields SF1, SF2, . . . , SF10, and the subfields are assigned a specific luminance weight such as 1, 2, 3, 6, 11, 18, 30, 44, 60, 80. The all-cell initialization operation is applied in the initialization period of subfield SF1, and the selective initialization operation is applied in the initialization period of subfields SF2 to SF10. As a result, discharge not related to image display occurs only as a result of the discharge in the all-cell initialization operation in subfield SF1. Because the black luminance representing the luminance in black display areas does not produce a sustain discharge and results only from the weak emission of the all-cell initialization operation, a high contrast image display is possible. In addition, in the sustain period of each subfield, a number of sustain pulses equal to the luminance weight of each subfield multiplied by a predetermined luminance scaling factor is applied to each display electrode pair 24.

However, the subfield count and the luminance weight of each subfield are not limited to the values described above, and the subfield configuration may be changed based on the image signal, for example.

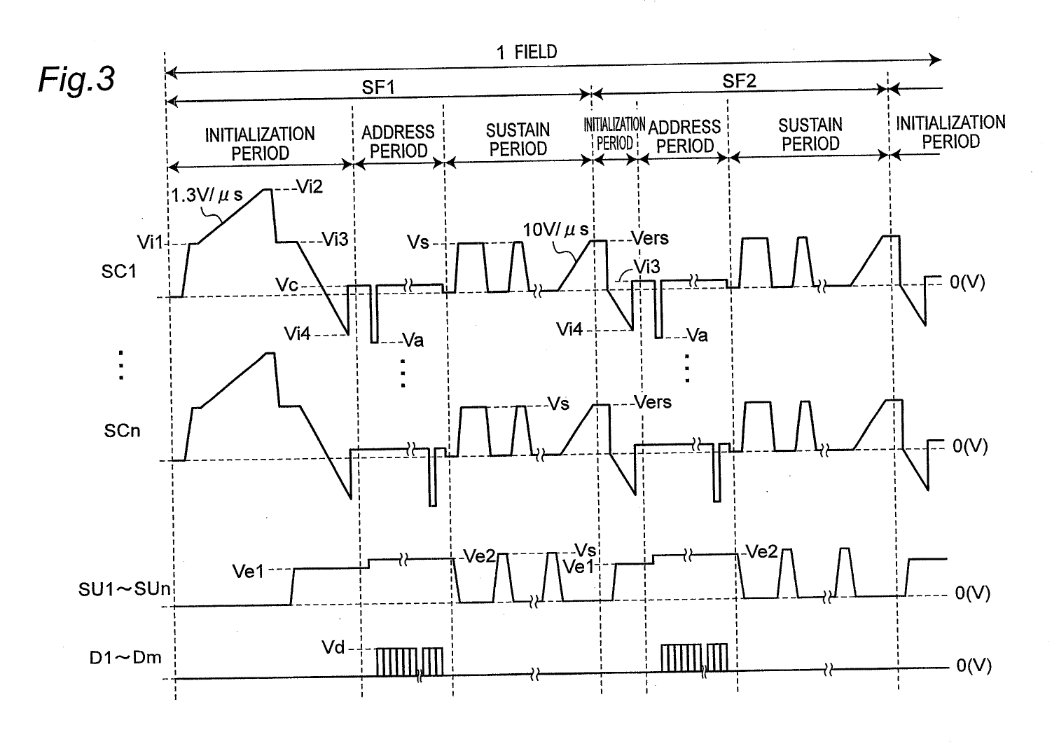

FIG. 3 is a waveform diagram of the drive voltages applied to the electrodes of the panel 10. The drive voltage waveform of two subfields, specifically a subfield to which the all-cell initialization operation is applied (“all-cell initialization subfields” below) and a subfield to which the selective initialization operation is applied (“selective initialization subfields” below) are shown in FIG. 3, but the drive voltage waveforms in the other subfields are substantially the same. Note also that the scan electrode SCi, sustain electrode SUi, and data electrode Dj below denote the electrodes selected from among all electrodes based on the image data.

Subfield SF1, which is an all-cell initialization subfield, is described first below.

In the first half of the initialization period in subfield SF1, 0 V is applied to data electrodes D1 to Dm and sustain electrodes SU1 to SUn, and an inclined waveform voltage (“ramp-up waveform voltage” below) that rises gradually from a positive voltage Vi1, which is less than or equal to the discharge start voltage applied to the sustain electrodes SU1 to SUn, to a positive voltage Vi2 exceeding the discharge start voltage is applied to scan electrodes SC1 to SCn.

While the ramp-up waveform voltage is rising, a weak initialization discharge is sustained between the scan electrodes SC1 to SCn and sustain electrodes SU1 to SUn and the data electrodes D1 to Dm. A negative wall voltage accumulates in the top part of the scan electrodes SC1 to SCn, and a positive wall voltage accumulates in the top part of the data electrodes D1 to Dm and the top part of the sustain electrodes SU1 to SUn. Note that a wall voltage in the top part of an electrode denotes a voltage produced by the wall charge accumulated on the dielectric layers covering the electrodes, the protective layer, and the phosphor layer.

In the second half of the initialization period, a positive voltage Ve1 is applied to sustain electrodes SU1 to SUn, 0 V is applied to data electrodes D1 to Dm, and an inclined waveform voltage (“ramp-down waveform voltage” below) that drops gradually from a positive voltage Vi3, which is less than or equal to the discharge start voltage applied to the sustain electrodes SU1 to SUn, to a negative voltage Vi4 greater than the discharge start voltage is applied to the scan electrodes SC1 to SCn. During this time a weak initialization discharge is sustained between the scan electrodes SC1 to SCn and sustain electrodes SU1 to SUn and the data electrodes D1 to Dm. The negative wall voltage in the top part of the scan electrodes SC1 to SCn and the positive wall voltage in the top part of the sustain electrodes SU1 to SUn weakens, and the positive wall voltage in the top part of the data electrodes D1 to Dm is adjusted to a value appropriate to the address operation.

This completes the all-cell initialization operation that produces an initialization discharge in all discharge cells.

Note that as shown in the initialization period for subfield SF2 in FIG. 3 a drive voltage waveform that omits the first half of the initialization period may be applied to each electrode. More specifically, a positive voltage Ve1 is applied to the sustain electrodes SU1 to SUn and 0 V is applied to data electrodes D1 to Dm, and a ramp-down waveform voltage that drops from a voltage (such as the ground potential) that is less than or equal to the discharge start voltage to a negative voltage Vi4 is applied to the scan electrodes SC1 to SCn. As a result, a weak initialization discharge is produced in the discharge cells where a sustain discharge was produced in the sustain period of the previous subfield, and the wall voltage of the top part of the scan electrode SCi and the top part of the sustain electrode SUi weakens. In the discharge cells where a sufficient positive wall voltage is accumulated in the top part of the data electrode Dj (j=1 to m) by the immediately preceding sustain discharge, the excessive part of this wall voltage is discharged and the wall voltage is adjusted to a wall voltage appropriate to the address operation. The discharge cells in which a sustain discharge was not produced in the previous subfield do not discharge, and the wall voltage is held at the wall voltage when the initialization period of the previous subfield ended. This initialization operation thus omitting the first half described above is the selective discharge operation producing an initial discharge in the discharge cells to which the sustain operation was applied in the sustain period of the immediately preceding subfield.

In the following address period voltage Ve2 is first applied to the sustain electrodes SU1 to SUn and a positive voltage Vc is applied to the positive scan electrodes SC1 to SCn.

A negative scan pulse voltage Va is then applied to the scan electrode SC1 of row 1 and a positive address pulse voltage Vd is applied to the data electrodes Dj (j=1 to m) selected from the group of data electrodes D1 to Dm of the discharge cells on row 1 that are to emit. The voltage difference on the data electrode Dj and on the scan electrode SC1 at the intersection thereof is the difference (Vd−Va) of the externally applied voltages and the difference between the wall voltage on the data electrode Dj and the wall voltage on the scan electrode SC1, and exceeds the discharge start voltage. As a result, a discharge is produced between the data electrode Dj and the scan electrode SC1.

In addition, because positive voltage Ve2 is applied to the sustain electrodes SU1 to SUn, the voltage difference on the sustain electrode SU1 and on the scan electrode SC1 is the difference (Ve2−Va) between the externally applied voltages and the difference between the wall voltage on the sustain electrode SU1 and the wall voltage on the scan electrode SC1. By setting voltage Ve2 at this time to a voltage slightly lower than the discharge start voltage, the space between the sustain electrode SU1 and the scan electrode SC1 can be primed to easily produce a discharge while not actually discharging. As a result, discharge produced between the data electrode Dj and the scan electrode SC1 can be used as a trigger to cause a discharge between the sustain electrode SU1 and the scan electrode SC1 in the area intersecting with the data electrode Dj. This causes an address discharge in the discharge cell that should emit, stores a positive wall voltage on the scan electrode SC1, a negative wall voltage on the sustain electrode SU1, and a negative wall voltage on the data electrode Dj.

An address operation that produces an address discharge in the discharge cells that are to emit on row 1, and accumulates a wall voltage on each electrode, is thus executed. However, because the voltage at the intersection of the scan electrode SC1 and the data electrodes D1 to Dm to which the address pulse voltage Vd was not applied does not exceed the discharge start voltage, an address discharge is not emitted. This address operation is repeated to the discharge cells on row n, and the address period then ends.

In the following sustain period a positive sustain pulse voltage Vs is first applied to the scan electrodes SC1 to SCn, and the ground potential, that is, 0 V, is applied to the sustain electrodes SU1 to SUn. As a result, the voltage difference between the scan electrode SC1 and the sustain electrode SU1 in the discharge cells where an address discharge was not produced is the sustain pulse voltage Vs plus the difference between the wall voltage on the scan electrode SCi and the wall voltage on the sustain electrode SUi, and exceeds the discharge start voltage.

A sustain discharge is thus produced between the scan electrode SCi and sustain electrode SUi, and the UV light produced at this time causes the phosphor layer 35 to emit. A negative wall voltage is thus stored on the scan electrode SCi and a positive wall voltage is stored on the sustain electrode SUi. A positive wall voltage is also stored on the data electrode Dj. A sustain discharge is not produced in the discharge cells where an address discharge does not occur in the address period, and the wall voltage at the end of the initialization period is sustained.

A reference potential of 0 V is then applied to the scan electrodes SC1 to SCn, and a positive sustain pulse voltage Vs is applied to the sustain electrodes SU1 to SUn. As a result, the voltage difference on the sustain electrode SUi and the scan electrode SCi exceeds the discharge start voltage in the discharge cells that produced a sustain discharge. As a result, a sustain discharge occurs between the sustain electrode SUi and scan electrode SCi again, a negative wall voltage is stored on the sustain electrode SUi, and a positive wall voltage is stored on the scan electrode SCi. Thereafter, a number of sustain pulses equal to the luminance weight multiplied by the luminance scale factor is alternately applied to the scan electrodes SC1 to SCn and sustain electrodes SU1 to SUn, thus writing a potential difference between the electrodes of the display electrode pairs 24. As a result, a sustain discharge is sustained in the discharge cells that produced an address discharge in the address period.

At the end of the sustain period, an inclined waveform voltage (“erase ramp waveform voltage” below) that rises gradually from the reference potential of 0 V toward a positive voltage Vers is applied to the scan electrodes SC1 to SCn. This causes a weak discharge to be sustained while erasing part or all of the wall voltages on the scan electrode SCi and sustain electrode SUi while leaving the positive wall voltage on the data electrode Dj.

More specifically, after the sustain electrodes SU1 to SUn return to 0 V, an erase ramp waveform voltage that rises from the reference potential of 0 V toward a positive voltage Vers that exceeds the discharge start voltage is generated and applied to the scan electrodes SC1 to SCn. A weak discharge is thus produced between the sustain electrode SUi and scan electrode SCi of the discharge cells that produced a sustain discharge. This weak discharge is sustained throughout the period in which the voltage applied to the scan electrodes SC1 to SCn rises.

The charged particles produced by this weak discharge are stored as a wall charge on the sustain electrode SUi and the scan electrode SCi in order to buffer the voltage difference between the sustain electrode SUi and scan electrode SCi. As a result, while the positive wall charge is left on the data electrode Dj, the wall voltages between the scan electrodes SC1 to SCn and sustain electrodes SU1 to SUn weaken to the difference between the voltage applied to the scan electrode SCi and the discharge start voltage, that is, to approximately voltage Vers minus the discharge start voltage. The last discharge in the sustain period produced by this erase ramp waveform voltage is referred to as the “erase discharge” below.

The operation in the next subfield is substantially identical to the operation described above except for the number of sustain pulses in the sustain period.

The foregoing summarizes the drive voltage waveform applied to the electrodes of the panel 10.

As further described below, the work of an auxiliary circuit cancels the peak current occurring when a sustain pulse is generated, and balances canceling reactive power and reducing EMI (electromagnetic interference) with achieving a stable sustain discharge.

The configuration of a plasma display device is described next.

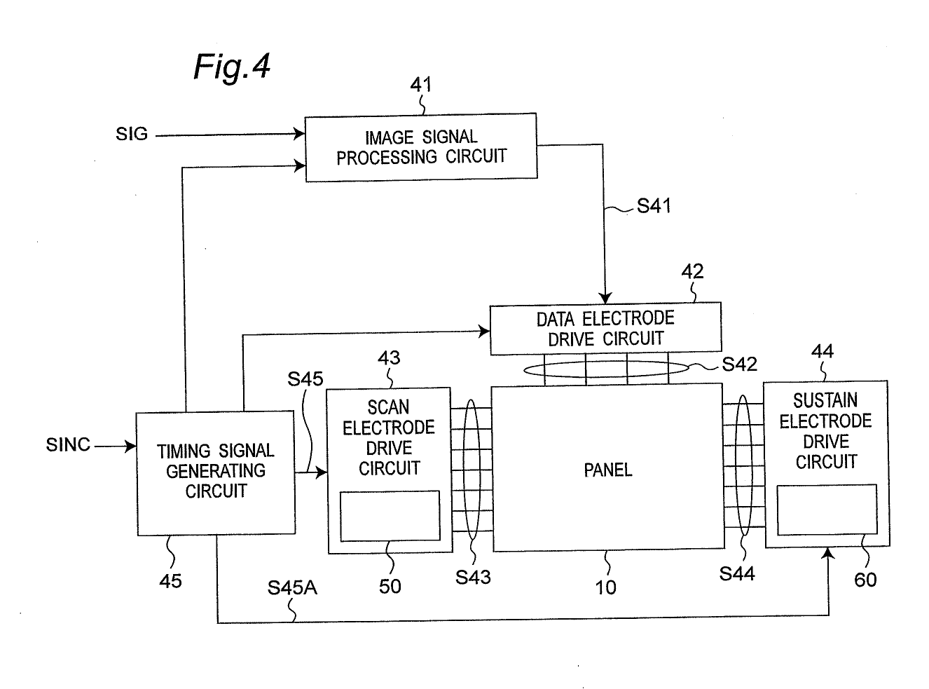

FIG. 4 is a circuit block diagram of a plasma display device. As shown in FIG. 4 the plasma display device 1 has a panel 10, an image signal processing circuit 41, a data electrode drive circuit 42, a scan electrode drive circuit 43, a sustain electrode drive circuit 44, a timing signal generating circuit 45, and a power supply circuit (not shown in the figure) that supplies the necessary power to the other circuit blocks.

The image signal processing circuit 41 converts the input image signal SIG to image data S41 describing whether each subfield emits or does not emit.

The data electrode drive circuit 42 converts the image data S41 for each subfield to data electrode drive signals S42 corresponding to each of the data electrodes D1 to Dm, and drives the data electrodes D1 to Dm.

The timing signal generating circuit 45 generates various timing signals S45 that control the operation of the scan electrode drive circuit 43 based on an image synchronization signal SINC representing the horizontal synchronization signal H and vertical synchronization signal V of the image signal SIG, and supplies the timing signals S45 to the scan electrode drive circuit 43. The timing signal generating circuit 45 similarly generates various timing signals S45A controlling the operation of the sustain electrode drive circuit 44 based on the image synchronization signal SING, and supplies these timing signals S45A to the sustain electrode drive circuit 44.

The scan electrode drive circuit 43 has an initialization waveform generating circuit (not shown in the figure), a sustain pulse generating circuit 50, and a scan pulse generating circuit (not shown in the figure).

The initialization waveform generating circuit generates the initialization waveform voltage that is applied to the scan electrodes SC1 to SCn in the initialization period.

The sustain pulse generating circuit 50 generates the sustain pulses applied to the scan electrodes SC1 to SCn in the sustain period.

The scan pulse generating circuit generates the scan pulse voltage applied to the scan electrodes SC1 to SCn in the address period.

The scan electrode drive circuit 43 generates a scan electrode drive signal S43 based on the timing signal S45 output from the timing signal generating circuit 45, and drives the scan electrodes SC1 to SCn.

The sustain electrode drive circuit 44 includes a sustain pulse generating circuit 60, and a circuit for generating voltage Ve1 and voltage Ve2, and similarly generates sustain electrode drive signals S44 based on the timing signals S45A, and drives the sustain electrodes SU1 to SUn.

The configuration and operation of the sustain pulse generating circuit 50 and sustain pulse generating circuit 60 are described in detail next.

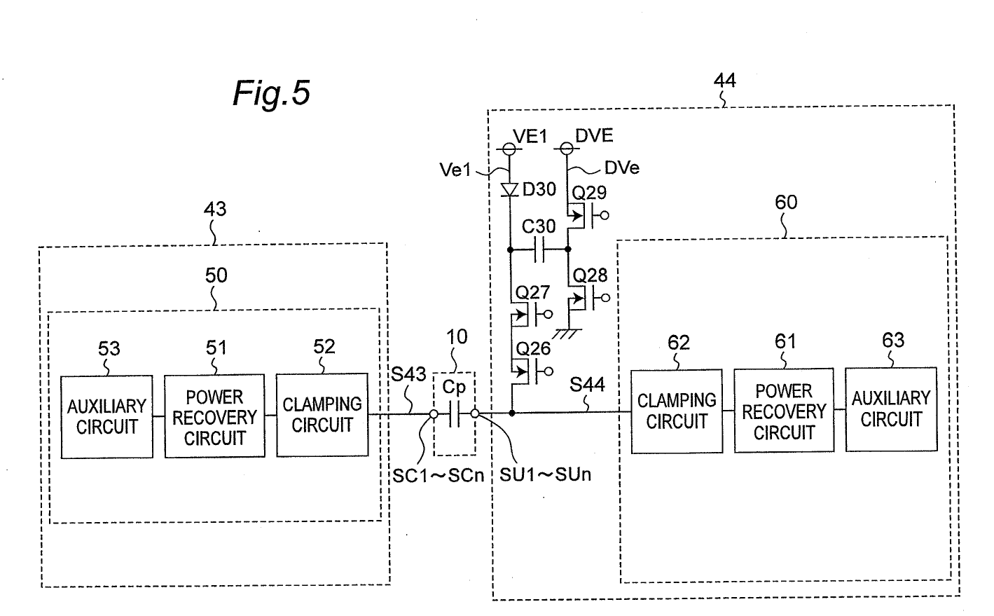

FIG. 5 is a circuit block diagram of the sustain pulse generating circuit 50 and the sustain pulse generating circuit 60. In FIG. 5 the panel 10 is shown as an interelectrode capacitance Cp, and the scan pulse generating circuit and initialization waveform generating circuit are omitted.

The sustain pulse generating circuit 50 includes a power recovery circuit 51, a clamping circuit 52, and an auxiliary circuit 53.

The power recovery circuit 51 recovers the power accumulated in the interelectrode capacitance Cp, which is the capacitive load of the display electrode pair 24, into a recovery capacitor by LC resonance, and reuses the recovered power to drive the scan electrodes SC1 to SCn.

The clamping circuit 52 clamps the scan electrodes SC1 to SCn to voltage Vs and the ground potential.

The auxiliary circuit 53 provides auxiliary control of the current flowing to the scan electrodes SC1 to SCn from the recovery capacitor of the power recovery circuit 51 when driving the scan electrodes SC1 to SCn, and the current flowing from the interelectrode capacitance Cp. The auxiliary circuit 53, power recovery circuit 51, and clamping circuit 52 are connected to the scan electrodes SC1 to SCn, which are one end of the interelectrode capacitance Cp of the panel 10, through the initialization waveform generating circuit and scan pulse generating circuit. During the sustain period the sustain pulse generating circuit 50 is electrically shorted to the scan electrodes SC1 to SCn, and the initialization waveform generating circuit and scan pulse generating circuit are electrically open. As a result, the initialization waveform generating circuit and scan pulse generating circuit are not shown in the figure.

Similarly to the sustain pulse generating circuit 50, the sustain pulse generating circuit 60 also has a power recovery circuit 61, a clamping circuit 62, and a auxiliary circuit 63. The auxiliary circuit 63, power recovery circuit 61, and clamping circuit 62 are connected to sustain electrodes SU1 to SUn, which are one end of the interelectrode capacitance Cp of the panel 10.

The sustain electrode drive circuit 44 also has a power source VE1, switching element Q26, switching element Q27, power source DVE, diode D30, capacitor C30, switching element Q28, and switching element Q29. The power source VE1 outputs voltage Ve1. Switching element Q26 and switching element Q27 switch applying voltage Ve1 to the sustain electrodes SU1 to SUn. Power source DVE produces voltage DVe. Diode D30 prevents current backflow to the power source VE1. Capacitor C30 functions as a charge pump adding voltage DVe to voltage Ve1. Switching element Q28 and switching element Q29 adds voltage DVe to voltage Ve1, and outputs voltage Ve2.

For example, at the timing when voltage Ve1 shown in FIG. 3 is applied, switching element Q26 and switching element Q27 are energized, and a positive voltage Ve1 is applied to sustain electrodes SU1 to SUn through diode D30, switching element Q26, and switching element Q27. At this time switching element Q28 is energized and charged until the voltage of capacitor C30 goes to voltage Ve1.

In addition, at the timing when voltage Ve2 in FIG. 3 is applied, switching element Q26 and switching element Q27 remain energized while switching element Q28 is cut off and switching element Q29 is energized.

Voltage DVe is superposed on the voltage of capacitor C30, and voltage Ve1+DVe, that is, voltage Ve2, is applied to sustain electrodes SU1 to SUn. Backflow prevention diode D30 cuts off the current flow from the capacitor C30 to the power source VE1 at this time.

Note that the circuit for applying voltage Ve1 and voltage Ve2 is not limited to the circuit configuration shown in FIG. 5. For example, a power source that produces voltage Ve1, a power source that produces voltage Ve2, and a plurality of switching elements that apply the voltages to the sustain electrodes SU1 to SUn can be used, and the voltages can be applied to the sustain electrodes SU1 to SUn at the required timing.

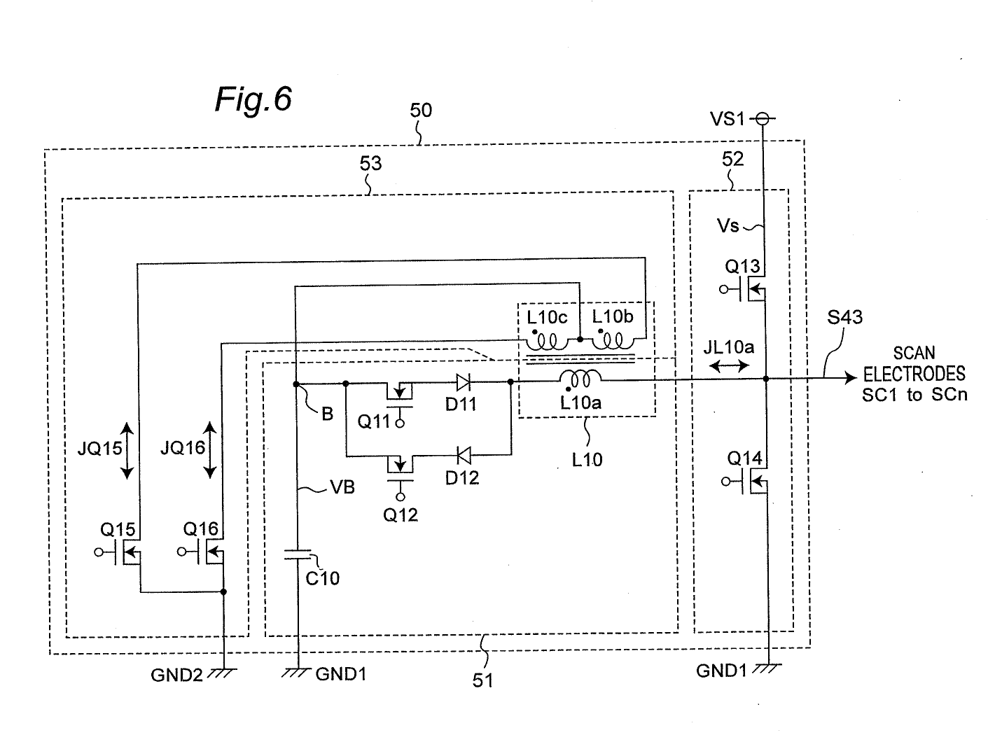

The configuration and operation of the auxiliary circuit 53, power recovery circuit 51, and clamping circuit 52 are described next. FIG. 6 is a circuit diagram of the sustain pulse generating circuit 50.

Potential is expressed as a positive, 0, or negative voltage between the ground terminal and any desired measurement point of the circuit.

Power source VS1 supplies potential Vs and a reference potential (such as the ground potential) to the sustain pulse generating circuit 50 and sustain pulse generating circuit 60.

The sustain pulse generating circuit 50 supplies a sustain pulse identified by potential Vs and the reference potential through the scan electrode drive signal S43 to the scan electrodes SC1 to SCn in the sustain period.

The sustain pulse generating circuit 60 supplies the sustain pulse identified by potential Vs and the reference potential through the sustain electrode drive signal S44 to the sustain electrodes SU1 to SUn in the sustain period.

In the sustain period, the scan electrode drive signal S43 goes to the reference potential when the sustain electrode drive signal S44 is potential Vs, and goes to potential Vs when the sustain electrode drive signal S44 is the reference potential. In the sustain period, therefore, a positive voltage Vs and a negative voltage −Vs are alternately applied to both ends of the n interelectrode capacitances Cp formed between the scan electrodes SC1 to SCn and the sustain electrodes SU1 to SUn.

Note that because potential Vs and the reference potential represent a positive, 0, or negative voltage between the measurement point and the ground potential (0 V), they are also referred to as voltage Vs and a reference voltage (such as 0 V), respectively.

The direction of current flow from the sustain pulse generating circuit 50 to the interelectrode capacitance Cp is called the forward direction, and the direction of current flow from the interelectrode capacitance Cp to the sustain pulse generating circuit 50 is reverse. For brevity below, the energy (or power) that produces current flowing forward is called forward energy (or power), and the energy (or power) that produces current flowing in reverse is called reverse energy (or power).

The forward direction is also called the supply direction, and the reverse direction is also called the recovery direction.

The configuration of the sustain pulse generating circuit 50 is outlined next below with reference to FIG. 6.

The sustain pulse generating circuit 50 drives the interelectrode capacitance Cp using primary power and auxiliary power. The sustain pulse generating circuit 50 includes a power recovery circuit 51 and auxiliary circuit 53.

The power recovery circuit 51 includes a capacitor C10 and an inductor L10a. The capacitor C10 can store and discharge primary power. Based on the LC resonance of the interelectrode capacitance Cp and inductor L10a, the power recovery circuit 51 recovers primary power from the interelectrode capacitance Cp into the capacitor C10 through the inductor L10a, and supplies the recovered primary power from the capacitor C10 through the inductor L10a to the interelectrode capacitance Cp.

The auxiliary circuit 53 includes an inductor L10b and an inductor L10c. The inductor L10b and inductor L10c can store and discharge auxiliary power. The inductor L10a is coupled to the inductor L10b and inductor L10c by mutual induction, and can store and discharge auxiliary power from inductor L10b and inductor L10c. The power recovery circuit 51 thus adds auxiliary power to the primary power, and can quickly recover and supply primary power.

The auxiliary circuit 53 charges the inductor L10c with auxiliary power just before primary power recovery starts so that the inductor L10a is charged in the recovery direction. When primary power recovery starts, the power recovery circuit 51 discharges the auxiliary power charged in the recovery direction at the primary induction part in the recovery direction.

The auxiliary circuit 53 also charges inductor L10b with the auxiliary power before the primary power supply starts so that the inductor L10a is charged in the supply direction. When the primary power supply starts, the power recovery circuit 51 discharges the auxiliary power charged in the supply direction at the main induction part in the supply direction.

The configuration of the power recovery circuit 51 and auxiliary circuit 53 can also be described as follows from a different point of view.

The power recovery circuit 51 and auxiliary circuit 53 include a capacitor C10, inductor L10b and inductor L10c, inductor L10a, a recovery path, a supply path, a recovery charge path, a recovery discharge path, a supply charge path, and a supply discharge path.

The capacitor C10 can store and discharge primary power. Inductor L10b and inductor L10c can store auxiliary power. Inductor L10a is coupled to inductor L10b and inductor L10c by mutual induction, can store and discharge auxiliary power from the inductor L10b and inductor L10c, and LC resonates with the interelectrode capacitance Cp.

The recovery path is a path for recovering primary power from the interelectrode capacitance Cp through inductor L10a to the capacitor C10 based on LC resonance.

The supply path is a path for supply the recovered primary power from the capacitor C10 through the inductor L10a to the interelectrode capacitance Cp based on LC resonance.

The recovery charge path is a path through the inductor L10c, and is a path for pumping auxiliary power to the inductor L10c to charge the inductor L10a in the recovery direction, that is, in the direction enhancing the primary power recovery operation.

The recovery discharge path is a path through the inductor L10a, and is a path for discharging auxiliary power pumped in the recovery direction at the inductor L10a in the recovery direction.

The supply charge path is a path through inductor L10b, and is a path for pumping auxiliary power to the inductor L10b so that the inductor L10a is charged in the supply direction, that is, the direction strengthening the primary power supply operation.

The supply discharge path is a path through inductor L10a, and is a path for discharging the auxiliary power charged in the supply direction at the inductor L10a in the supply direction.

The recovery path is separate from the recovery charge path, and is the same as the recovery discharge path.

The supply path is separate from the supply charge path, and is the same as the supply discharge path.

Inductor L10c charges the auxiliary power in the recovery direction immediately before primary power recovery starts, and when primary power recovery starts the inductor L10a discharges the auxiliary power charged in the recovery direction in the recovery direction. Inductor L10b charges the auxiliary power in the supply direction immediately before primary power supply starts. When primary power supply starts, the inductor L10a then discharges in the supply direction the auxiliary power that was charged in the supply direction.

The sustain pulse generating circuit 50 includes a clamping circuit 52.

The clamping circuit 52 holds the scan electrodes SC1 to SCn of the interelectrode capacitance Cp to potential Vs by the power source VS1 that supplies potential Vs, and holds (that is, clamps) the scan electrodes SC1 to SCn of the interelectrode capacitance Cp to the reference potential by the reference power source GND1 that supplies the reference potential. In the steady state following a predetermined period after the power source VS1 turns on, the power recovery circuit 51 recovers and supplies most of the primary power. The clamping circuit 52 supplies the slightly deficient part of the primary power to the scan electrodes SC1 to SCn in the steady state by clamping the scan electrodes SC1 to SCn to potential Vs and the reference potential.

The interelectrode capacitance Cp is an example of a capacitive load. The power recovery circuit 51 is an example of a power feedback circuit, and the clamping circuit 52 is an example of a holding circuit. The reference power source GND1 is also called a reference terminal. The reference terminal denotes a ground terminal, for example. The potential Vs of power source VS1 is also called the primary potential, and the potential of the reference power source GND1 is also called a reference potential. The reference potential is, for example, equal to the ground potential.

The capacitor C10 is an example of a recovery capacitor or primary capacitance unit. The inductor L10a is an example of a recovery inductor or primary induction unit.

An inductor including inductor L10b and inductor L10c is an example of an auxiliary inductor or auxiliary induction unit. The primary capacitance unit may have a plurality of capacitors, or the primary induction unit and auxiliary induction unit may each have a plurality of inductors.

A preferred configuration is described below in detail.

The power recovery circuit 51 includes capacitor C10, switching element Q11, switching element Q12, diode D11, diode D12, and inductor L10a. Switching element Q11 closes when power is supplied from the recovery capacitor C10 to the scan electrodes SC1 to SCn. Switching element Q12 closes during power recovery from the scan electrodes SC1 to SCn to the recovery capacitor C10. Diode D11 prevents the backflow of current from the recovery capacitor C10 to the scan electrodes SC1 to SCn when supplying power in the forward direction. Diode D12 prevents current backflow during power recovery from the scan electrodes SC1 to SCn to the recovery capacitor C10.

One terminal of the capacitor C10 is connected to terminal GND1, and is set to the ground potential, which is the reference potential. Switching element Q11 and diode D11, which are connected in series with each other, and switching element Q12 and diode D12, which are connected in series with each other, are parallel connected so that the current flowing therethrough flows in opposite directions. In addition, the other terminal of the capacitor C10 (node B in this example) and one terminal of the inductor L10a are connected in series, and the other terminal of the inductor L10a is connected to scan electrodes SC1 to SCn. The circuit including switching element Q11, diode D11, switching element Q12, and diode D12 is also called a two-way switch.

The power recovery circuit 51 causes recovery inductor L10a and interelectrode capacitance Cp to LC resonate, and shapes the rising and falling edges of the sustain pulses. The power recovery circuit 51 thus drives the scan electrodes SC1 to SCn by the LC resonance of the recovery inductor L10a and interelectrode capacitance Cp. The voltage of capacitor C10 is charged to approximately half of voltage Vs (that is, Vs/2) so that the power recovery capacitor C10 has capacitance sufficiently greater than the interelectrode capacitance Cp and can work as a power source of the power recovery circuit 51. More specifically, one terminal of the capacitor C10 goes to the ground potential, and the other terminal (that is, node B) goes to potential VB (=Vs/2).

The clamping circuit 52 includes switching element Q13 and switching element Q14. The scan electrodes SC1 to SCn are connected through switching element Q13 to power source VS1, and are connected through switching element Q14 to ground terminal GND1. When switching element Q13 is on, the clamping circuit 52 clamps scan electrodes SC1 to SCn to potential Vs, and when switching element Q14 is on clamps scan electrodes SC1 to SCn to potential 0 (V). Impedance is therefore low when voltage is supplied by the clamping circuit 52, and a stable high discharge current can be passed by a strong sustain discharge.

The auxiliary circuit 53 includes switching element Q15, switching element Q16, inductor L10b, and inductor L10c.

Switching element Q15 is an auxiliary switch that conducts when current JQ15 is supplied to inductor L10b. Switching element Q16 is an auxiliary switch that conducts when current JQ16 is supplied to inductor L10c. Inductor L10a, inductor L10b, and inductor L10c form a mutual inductor L10. The mutual inductor L10 is also called a transformer, and may also be broadly referred to as a recovery inductor. As described above, the recovery inductor points narrowly to only inductor L10a, and unless otherwise specified below a recovery inductor means only inductor L10a. The inductor formed by connecting the inductor L10b and inductor L10c in series is an example of an auxiliary induction unit or auxiliary inductor. The inductors L10b and L10c are examples of secondary auxiliary induction units or secondary auxiliary inductors. Inductor L10a of the mutual inductor L10 is included in the power recovery circuit 51 and operates as a main induction unit. Inductor L10b and inductor L10c are included in the auxiliary circuit 53, and operate as auxiliary induction units.

One terminal of switching element Q15 is connected to one terminal of inductor L10b, and the other terminal of switching element Q15 is connected to ground terminal GND2 (also called a reference terminal) and goes to ground, that is, the reference potential.

One terminal of switching element Q16 is connected to one terminal of inductor L10c, and the other terminal of switching element Q16 is connected to ground terminal GND2 and goes to ground, that is, the reference potential.

The node between the other terminal of inductor L10b and the other terminal of inductor L10c is connected to the other terminal (that is, node B) of capacitor C10.

The inductor L10a, inductor L10b, and inductor L10c each have a predetermined self-induction due to self-inductance. In addition, the auxiliary inductors (L10b, L10c) and recovery inductor L10a are magnetically coupled together by mutual induction, and have a predetermined mutual inductance. The sign of this mutual inductance is determined by the structure of the magnetic core producing the mutual induction, and the winding directions of the coils of the inductors L10a, L10b, L10c. In FIG. 6 mutual inductor L10 is formed by winding the coils of the auxiliary inductors (L10b, L10c) and the coil of the recovery inductor L10a in the same direction around a pole-shaped magnetic core. The mutual inductor L10 is not limited to the configuration shown in FIG. 6, and may, for example, have a toroidal magnetic core with the winding direction of each coil changing as needed to achieve the same operation as the configuration described in FIG. 6.

Forward current JL10a flows in the direction to recovery inductor L10a as a result of current JQ15 flowing from capacitor C10 in the direction of switching element Q15 at inductor L10b. Reverse current JL10a flows to recovery inductor L10a as a result of current JQ16 flowing in the direction from capacitor C10 to switching element Q16 at inductor L10c. When forward current or energy (or power) is produced in the recovery inductor L10a as a result of current flowing to the auxiliary inductor (L10b, L10c) or energy (or power) produced in the auxiliary inductor, the direction of the current flowing to the auxiliary inductor or the energy (or power) produced in the auxiliary inductor is called the forward direction (or supply direction). Conversely, when reverse current or energy (or power) is produced in the recovery inductor L10a by the current flowing to the auxiliary inductor (L10b, L10c) or the energy (or power) produced in the auxiliary inductor, the direction of the current flowing to the auxiliary inductor or the energy (or power) produced in the auxiliary inductor is called the reverse direction (or recovery direction).

The current flowing through the auxiliary inductor is also called primary current, and the energy (or power) produced in the auxiliary inductor is also called primary energy (or primary power).

In addition, the current flowing through recovery inductor L10a as a result of mutual induction from the primary current or primary energy (or primary power) is also called secondary current, and the energy (or power) produced (or stored) in recovery inductor L10a is also called secondary energy (or secondary power).

Furthermore, the primary current is also called primary auxiliary current, and the primary energy (or primary power) is also called primary auxiliary energy (or primary auxiliary power).

The secondary current is also called secondary auxiliary current, and the secondary energy (or secondary power) is also called secondary auxiliary energy (or secondary auxiliary power).

The sustain pulse generating circuit 50 is controlled based on the timing signal S45 output from the timing signal generating circuit 45, and opens and closes switching element Q11, switching element Q12, switching element Q13, switching element Q14, switching element Q15, and switching element Q16. As a result, the sustain pulse generating circuit 50 operates the power recovery circuit 51, clamping circuit 52, and auxiliary circuit 53, and generates the sustain pulse waveform.

For example, to make the sustain pulse waveform rise, switching element Q11 is energized, interelectrode capacitance Cp and recovery inductor L10a are caused to resonate, and current is passed and primary power is supplied from the recovery capacitor C10 through switching element Q11, diode D11, and inductor L10a to scan electrodes SC1 to SCn. This current is also called primary current.

Next, when the potential of scan electrode drive signal S43 in scan electrodes SC1 to SCn approaches potential Vs, switching element Q13 is energized, the circuit that drives scan electrodes SC1 to SCn is switched from power recovery circuit 51 to clamping circuit 52, and scan electrodes SC1 to SCn are clamped to potential Vs.

Conversely, to make the sustain pulse waveform fall, switching element Q12 is energized, interelectrode capacitance Cp and recovery inductor L10a are caused to resonate, primary current is passed from interelectrode capacitance Cp through the reverse path through inductor L10a, diode D12, and switching element Q12 to the recovery capacitor C10, and primary power is recovered. Next, when the potential of scan electrode drive signal S43 on scan electrodes SC1 to SCn approaches 0 (V), switching element Q14 is energized. As a result, the circuit that drives scan electrodes SC1 to SCn is switched from power recovery circuit 51 to clamping circuit 52, and scan electrodes SC1 to SCn are clamped to the reference potential (0 V).

The sustain pulse generating circuit 50 thus generates sustain pulses. The switching elements Q11, Q12, Q13, Q14, Q15, Q16 can be formed by MOSFET (Metal Oxide Semiconductor Field Effect Transistor) or IGBT (Insulated Gate Bipolar Transistor) switching devices, for example.

Note, further, that switching element Q15 and switching element Q16 form a switching unit. The mutual inductor L10 can be set to the ground potential by closing the switching unit. Each switching element Q11, Q12, Q13, Q14, Q15, Q16 may be simply called a switch.

When switching element Q15 is energized, inductor L10b generates a primary auxiliary current flowing in the forward direction.

When switching element Q16 is energized, inductor L10c generates a primary auxiliary current flowing in the reverse direction.

As a result, switching element Q15 is also called a forward auxiliary switch, and switching element Q16 is also called a reverse auxiliary switch.

Immediately before boosting the sustain pulse waveform, that is, immediately before energizing switching element Q11, the auxiliary circuit 53 and power recovery circuit 51 close switching element Q15 and produce and produce primary auxiliary current JQ15 that flows from the recovery capacitor C10 through inductor L10b and switching element Q15 to ground terminal GND2. As a result, forward primary auxiliary energy is stored in (charged to) inductor L10b. At the same time, forward secondary auxiliary energy is stored (charged) in the inductor L10a that is coupled to inductor L10b by mutual induction.

Next, when switching element Q11 is closed and switching element Q15 is opened, primary auxiliary current JQ15 is cut off, secondary auxiliary energy is discharged forward at the recovery inductor L10a, and secondary auxiliary current that flows forward is generated.

The auxiliary circuit 53 and power recovery circuit 51 energize switching element Q16 immediately before lowering the sustain pulse waveform, that is, immediately before energizing switching element Q12, and generate the primary auxiliary current JQ16 that flows from the recovery capacitor C10 through inductor L10c and switching element Q16 to the ground terminal GND2. As a result, primary auxiliary energy in the reverse direction is stored (charged) to inductor L10c, and at the same time secondary auxiliary energy in the reverse direction is also stored (charged) to the inductor L10a coupled to inductor L10c by mutual induction. When switching element Q12 is next energized and switching element Q16 is opened, primary auxiliary current JQ16 is cut off, secondary auxiliary energy is instead discharged in the reverse direction at recovery inductor L10a, and secondary auxiliary current is produced flowing in the reverse direction.

The current flowing between the sustain pulse generating circuit 50 and interelectrode capacitance Cp when the sustain pulse rises and falls is thus the sum of the primary current that flows due to the LC resonance of the recovery inductor L10a and interelectrode capacitance Cp plus the secondary auxiliary current produced in the recovery inductor L10a by the forward primary auxiliary energy or negative primary auxiliary energy previously stored in inductor L10b or inductor L10c. As a result, the current supply is increased to greater than the primary current produced only by the LC resonance of the recovery inductor L10a and interelectrode capacitance Cp, the peak current when the sustain pulse is generated is suppressed, reactive power can be reduced and EMI can be reduced. This is described in detail below.

The sustain pulse generating circuit 60 is configured identically to the sustain pulse generating circuit 50. The sustain pulse generating circuit 60 includes a power recovery circuit 61, a clamping circuit 62, and a auxiliary circuit 63.

The power recovery circuit 61 is configured identically to the power recovery circuit 51, the clamping circuit 62 is configured identically to clamping circuit 52, and the auxiliary circuit 63 is configured identically to auxiliary circuit 53.

The sustain pulse generating circuit 60 is connected to sustain electrodes SU1 to SUn, which are one end of the interelectrode capacitance Cp of the panel 10. The operation of the sustain pulse generating circuit 60 is identical to the operation of the sustain pulse generating circuit 50, and further description thereof is omitted.

The period of the LC resonance (called the “resonance period” below) of the inductor L10a of the power recovery circuit 51 and the interelectrode capacitance Cp of the panel 10 can be obtained from the equation (2π√(LCp)) where L is the inductance of inductor L10a.

For example, inductor L10a is configured so that the resonance period at the power recovery circuit 51 is approximately 3 μsec, and the resonance period of the power recovery circuit 61 is set the same way. In addition, the frequency of the sustain pulse is set to 100 kHz, the period of the rise and fall of the sustain pulse is 1 μsec each, and the period for which the sustain pulse is clamped to potential Vs is set to 3 μsec. Note, however, that these values are used for example only, and may be set appropriately according to the characteristics of the panel and the specifications of the plasma display device.

The operation whereby the current JL10a flowing between the sustain pulse generating circuit 50 and interelectrode capacitance Cp (that is, to inductor L10a) when the sustain pulse rises and falls is increased to greater than the primary current produced only by the LC resonance of the inductor L10a and interelectrode capacitance Cp is described in detail next.

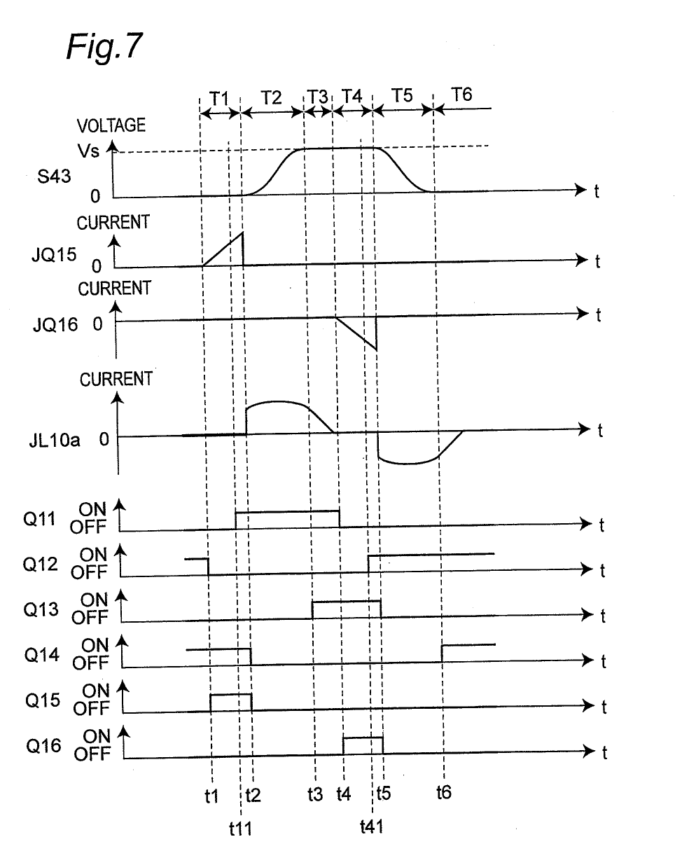

FIG. 7 is a timing chart describing the operation of the sustain pulse generating circuit. The operating sequence for generating the sustain pulse is divided into six periods denoted T1 to T6, each of which is described below. Note that while the operation of the sustain pulse generating circuit 50 is described below, the operation of the sustain pulse generating circuit 60 is the same.

In order from the top in FIG. 7, S43 denotes the change in the voltage of the scan electrode drive signal S43 applied to scan electrodes SC1 to SCn.

JQ15 denotes the change in the primary auxiliary current JQ15 flowing to switching element Q15 (note that the direction of flow from inductor L10b to switching element Q15 is forward).

JQ16 denotes the change in the primary auxiliary current JQ16 flowing to switching element Q16 (where the direction of flow from inductor L10c to switching element Q16 is the reverse direction).

JL10a denotes the change in current JL10a flowing to inductor L10a (where the direction of flow from capacitor C10 to inductor L10a is forward, and the direction of flow from inductor L10a to capacitor C10 is the reverse direction).

Q11 shows the control states of switching element Q11.

Q12 shows the control states of switching element Q12.

Q13 shows the control states of switching element Q13.

Q14 shows the control states of switching element Q14.

Q15 shows the control states of switching element Q15.

Q16 shows the control states of switching element Q16.

Note that in the following description and accompanying figures ON is an operation whereby a switching element is energized (closed), OFF is an operation whereby a switching element is interrupted (opened), a signal that turns a switching element on is labelled ON, and a signal that turns a switching element off is labelled OFF. In addition, a positive waveform denoting a forward sustain pulse voltage Vs is used for description in FIG. 7, but the invention is not so limited. For example, the same effect can be achieved using a negative waveform in an embodiment related to a negative waveform denoting a reverse sustain pulse voltage Vs by reading the rising edge of a positive wave in the following description as the falling edge of a negative wave.

### Period T1

Switching element Q15 turns on at time t1. As a result, primary auxiliary current JQ15 flows from recovery capacitor C10 through inductor L10b and switching element Q15 along a forward path to ground terminal GND2, which goes to ground. Because this path through which primary auxiliary current JQ15 flows is the path charging forward (in the supply direction) to the inductor L10b, it is also called the supply charge path. Because the potential VB at the node between capacitor C10 and inductor L10b (that is, node B) is Vs/2, the primary auxiliary current JQ15 flowing at this time increases at a slope of (Vs/2)/L where L is the inductance of inductor L10b. As a result, a forward primary auxiliary current JQ15 flows to inductor L10b, and forward primary auxiliary energy is stored in inductor L10b. Forward secondary auxiliary energy is also stored at the same time in inductor L10a by mutual induction.

In the following period T2 the power recovery circuit 51 is operated to supply power from recovery capacitor C10 to scan electrodes SC1 to SCn. Note that switching element Q11 is turned before time t2 at time t11 so that the secondary auxiliary current produced by the forward auxiliary energy stored in inductor L10b and inductor L10a quickly flows to inductor L10a at the transition from period T1 to period T2.

During this period switching element Q14 is held on and scan electrodes SC1 to SCn are clamped to 0 (V).

### Period T2

At time t2, switching element Q14 and switching element Q15 are turned off.

Because recovery inductor L10a and interelectrode capacitance Cp form a LC resonance circuit, LC resonance is produced by this switching operation. Based on this LC resonance, primary current flows and the primary power is supplied through the forward path from recovery capacitor C10 through switching element Q11, diode D11, and inductor L10a, and to scan electrodes SC1 to SCn. This path through which the primary current flows is also called the supply path. As a result, the potential of scan electrode drive signal S43 begins to rise at scan electrodes SC1 to SCn. For example, when the resonance period of recovery inductor L10a and interelectrode capacitance Cp is set to approximately 3 μsec, the potential of scan electrode drive signal S43 at scan electrodes SC1 to SCn approximately 1 μsec after time t2 rises to nearly potential Vs. The supply charge path shares only recovery capacitor C10 with the supply path, and as a path is actually separate from the supply path.

When switching element Q15 turns off at time t2, the primary auxiliary current JQ15 flowing through the supply charge path is cut off as shown in FIG. 7. At this time inductor L10b and inductor L10a stop the forward auxiliary energy charging operation from capacitor C10 and start the discharge operation. Because the path through inductor L10b is cut off, discharge starts on a path through inductor L10a, and secondary auxiliary current flows at inductor L10a. The auxiliary energy stored in inductor L10b and inductor L10a does not change before and after time t2. As a result, the secondary auxiliary current flowing through inductor L10a is substantially equal to the turn ratio of inductor L10b to inductor L10a multiplied by the primary auxiliary current JQ15 that was flowing to the inductor L10b immediately before being cut off as described in further detail below. The forward primary auxiliary energy stored in the inductor L10b is thus converted to forward secondary auxiliary current at inductor L10a. After time t2, secondary auxiliary current starts flowing along the forward path from the recovery capacitor C10 passed switching element Q11, diode D11, and inductor L10a to the scan electrodes SC1 to SCn as a result of the forward discharge resulting from the forward secondary auxiliary energy stored in inductor L10a.

Because this path through which the secondary auxiliary current flows is a path of discharge in the forward (supply) direction from inductor L10a, it is also called the supply discharge path. This secondary auxiliary current is added to the primary current that flows due to the LC resonance between inductor L10a and interelectrode capacitance Cp, and current JL10a rises rapidly forward. The supply discharge path is the same as the supply path.

As a result, the rise in current JL10a flowing to the scan electrodes SC1 to SCn is significantly sharper than only the primary current (not shown in the figure) resulting from the LC resonance of the recovery inductor L10a and interelectrode capacitance Cp as indicated by the waveform showing the change in current JL10a flowing to the inductor L10a in FIG. 7.

The secondary auxiliary current flowing to inductor L10a as a result of the forward energy stored in inductor L10b being converted to the forward energy of inductor L10a can be determined using the equation

Ia·Ib×Nb/Na

where Nb is the number of winds of inductor L10b, Ib is the primary auxiliary current, Na is the number of winds of inductor L10a, and Ia is the secondary auxiliary current. For example, when turn count Nb and turn count Na are equal, secondary current Ia is equal to primary current Ib. When turn count Nb is twice turn count Na, secondary current Ia can be made twice primary current Ib. Therefore, the resonance period of the LC resonance of inductor L10a and interelectrode capacitance Cp can be set using the turn count Na of inductor L10a, and the slope of the current supplied from the power recovery circuit 51 to scan electrodes SC1 to SCn when the sustain pulse rises can be set according to the turn count Nb of inductor L10b. In a preferred embodiment of the invention the turn count Nb of inductor L10b is greater than or equal to the turn count Na of inductor L10a.

Current flow from the power recovery circuit 51 to the scan electrodes SC1 to SCn can thus be quickly increased when the sustain pulse rises in period T2 using the forward energy stored in inductor L10b in period T1, and the rise in the sustain pulse can be accelerated. In addition, the peak current flowing to inductor L10a can be suppressed.

When power recovery circuit 51 and auxiliary circuit 53 are not used, the voltage of scan electrode drive signal S43 applied to scan electrodes SC1 to SCn peaks when half the resonance period has passed, but does not reach potential Vs due to power loss, for example. However, as described above, the secondary auxiliary current resulting from the forward primary energy stored in inductor L10b is added to the primary current that flows as a result of the LC resonance of inductor L10a and interelectrode capacitance Cp. As a result, the potential of scan electrode drive signal S43 that is applied to scan electrodes SC1 to SCn can be raised to potential Vs in less than half the time of the resonance period (that is, in a time of approximately 1 μsec compared with the approximately 3 μsec duration of the resonance period).

It is therefore possible to reduce reactive power and reduce EMI by reducing the peak current, and a sustain discharge can be stably produced as a result of reducing ringing by reducing the peak current. The voltage of the scan electrode drive signal S43 applied to the scan electrodes SC1 to SCn can also be boosted to a potential closer to potential Vs (and in this example can be boosted to potential Vs) by reducing reactive power. The power supply efficiency of the power recovery circuit 51 can thus be improved, the power supplied from power source VS1 to scan electrodes SC1 to SCn when switching to the following clamping circuit 52 can be suppressed, and power consumption can be further reduced.

The auxiliary circuit 53 is configured to pass the forward current that flows to inductor L10b to store energy in inductor L10b to ground terminal GND2 only through the minimum required circuitry (switching element Q15 in this example) without passing through unnecessary circuitry. As a result, reactive power and unnecessary heat output from switching element Q11 and diode D11 can be reduced.

Why the drive current JL10a flowing from the power recovery circuit 51 to the scan electrodes SC1 to SCn when the sustain pulse rises (or falls as described below) is the primary current that flows as a result of the LC resonance of the recovery inductor L10a and interelectrode capacitance Cp plus the auxiliary current of the energy stored in inductor L10b is described next.

As panel definition has increased, the number of electrodes that must be addressed in one subfield period has also increased. As a result, the time required for one address period also tends to increase, but because the amount of time that can be allocated to one subfield is limited, it is necessary to shorten the sustain period by, for example, shortening the sustain pulse period.

On the other hand, in order to produce a stable sustain discharge, it is necessary to consider such interference factors as the delay in producing a discharge, generally called the discharge delay, and variation in the discharge delay in different discharge cells.

The discharge generation delay time represents the time from when the voltage applied to a discharge cell exceeds the discharge start voltage until the actual discharge is produced. Due to these factors, a sufficient clamping period for clamping the sustain pulse to the potential Vs of power source VS1 and the ground potential must be assured. In order to shorten the sustain pulse period while also assuring a sufficient clamping period, it is necessary to make the sustain pulse rise and fall rapidly and shorten the sustain pulse rise and fall times.

Furthermore, if the discharge is produced with a sharp voltage change in the sustain operation, a strong discharge can be produced and a sufficient wall charge can be stored in the discharge cell. The effect of producing a stable discharge can also be improved because variation in the discharge start voltage can be absorbed and deviation in the sustain discharge between discharge cells can be suppressed by producing a discharge when there is a sharp voltage change.

It is therefore preferable to increase the current of the scan electrode drive signal S43 supplied from the sustain pulse generating circuit 50 to the scan electrodes SC1 to SCn as quickly as possible so that the sustain pulse rises as quickly as possible.

In order to achieve a sharp rising or falling edge to the sustain pulse, the inductance of the inductor L10a can be reduced to shorten the resonance period of the inductor L10a and interelectrode capacitance Cp, for example. However, if the resonance period of the recovery inductor L10a and interelectrode capacitance Cp is shortened, the maximum value of the current (the peak current) moving between the recovery capacitor C10 and interelectrode capacitance Cp increases and EMI increases.

In addition, if the peak current increases, the amount of power that is consumed needlessly without contributing to emission, that is, reactive power, also increases. Because the drive load is also higher in a high definition panel, reactive power may also increase.

Furthermore, because the output impedance of the power recovery circuit 51 is high relative to the output impedance of the clamping circuit 52, the increase in peak current produces waveform distortion called “ringing” due, for example, to the effect of the drive load. Such waveform distortion destabilizes discharge and increases reactive power.

Furthermore, because the voltage drop increases proportionally to the rise in the peak current, the voltage applied by the scan electrode drive signal S43 to the scan electrodes SC1 to SCn does not rise to voltage Vs when driven by the power recovery circuit 51. As a result, the power supplied from power source VS1 to scan electrodes SC1 to SCn when switching to the immediately following clamping circuit 52 increases, and power consumption rises.

However, if the resonance period of the power recovery circuit 51 that, for example, increases the inductance of the recovery inductor L10a becomes longer, the slope of the rise in the current JL10a supplied from the power recovery circuit 51 to the scan electrodes SC1 to SCn becomes more gradual. As a result, EMI can be reduced and reactive power can be reduced because the maximum value of the current (the peak current) moving between the recovery capacitor C10 and the interelectrode capacitance Cp is reduced. Yet further, because the voltage drop is suppressed, the applied voltage of scan electrode drive signal S43 to the scan electrodes SC1 to SCn when driven by the power recovery circuit 51 can be boosted to a potential closer to voltage Vs. As a result, the power supplied from power source VS1 to the scan electrodes SC1 to SCn when switching to the following clamping circuit 52 can be reduced, and power consumption can be reduced.

However, if the resonance period of the power recovery circuit 51 is increased and the edge characteristic describing the slope of the rising and falling edges of the sustain pulse is reduced, the sustain period increases accordingly, and this is a problem.

In order to reduce EMI and reactive power while stably driving a high definition panel, it is therefore necessary due to the foregoing to balance the mutually contradictory operations of achieving the sharpest possible edge characteristic when producing the sustain pulse while also decreasing the maximum value of the current, that is, the peak current, flowing between the sustain pulse generating circuit 50 and interelectrode capacitance Cp.

The sustain pulse generating circuit 50 is rendered to achieve this operation, and can render a sharp edge characteristic when producing sustain pulses while also reducing the peak current flow between the sustain pulse generating circuit 50 and interelectrode capacitance Cp.

More specifically, switching element Q15, which is a forward auxiliary switch, is energized to supply forward primary auxiliary current and store energy forward to the inductor L10b immediately before the sustain pulse waveform rises. Then immediately before the sustain pulse falls, switching element Q16, which is a reverse auxiliary switch, is energized and reverse primary auxiliary current is supplied to inductor L10c to store reverse energy.

As a result, the current flowing between the power recovery circuit 51 and scan electrodes SC1 to SCn immediately after power recovery circuit 51 operation starts can be made the primary current flowing due to the LC resonance of the recovery inductor L10a and interelectrode capacitance Cp plus the secondary auxiliary current resulting from the energy stored in inductor L10b or inductor L10c. More specifically, the sustain pulse can be rendered with a sharp rising edge and falling edge without shortening the resonance period of the inductor L10 and interelectrode capacitance Cp.

In addition, the secondary auxiliary current that flows to the scan electrodes SC1 to SCn due to the energy stored in inductor L10b drops sharply in conjunction with the rise in the potential of scan electrodes SC1 to SCn after switching element Q15 turns off. The rise in current when the sustain pulse rises is therefore transient. As a result, the peak current flowing between the sustain pulse generating circuit 50 and the interelectrode capacitance Cp is determined by the resonance period of the recovery inductor L10a and interelectrode capacitance Cp. In addition, by setting the inductance of the recovery inductor L10a so that the resonance period of the recovery inductor L10a and interelectrode capacitance Cp becomes longer, the peak current between the sustain pulse generating circuit and the interelectrode capacitance Cp can be suppressed.

It is therefore possible to reduce reactive power and reduce EMI by reducing the peak current, and a stable sustain discharge can be produced by reducing ringing as a result of reducing the peak current. Furthermore, the voltage of the scan electrode drive signal S43 applied to scan electrodes SC1 to SCn can be boosted to a potential closer to voltage Vs (to potential Vs in this embodiment) by reducing reactive power. As a result, the power utilization efficiency of the power recovery circuit 51 can be improved, the power supplied from power source VS1 to the scan electrodes SC1 to SCn when switching to the downstream clamping circuit 52 can be suppressed, and power consumption can be further reduced.

### Period T3

Switching element Q13 is then turned on at time t3. As a result, scan electrodes SC1 to SCn are set to potential Vs through switching element Q13.

Because the potential of the scan electrode drive signal S43 at scan electrodes SC1 to SCn is effectively driven to potential Vs by power recovery circuit 51, a real change in the potential of scan electrodes SC1 to SCn is not produced even if scan electrodes SC1 to SCn are clamped to potential Vs. As a result, the power supplied from the clamping circuit 52 to scan electrodes SC1 to SCn can be reduced. In addition, switching element Q13 is held on during the following period T4, and the potential of scan electrode drive signal S43 at scan electrodes SC1 to SCn is held to potential Vs in period T3 and period T4.

### Period T4

At time t4 switching element Q16 is turned on. As a result, primary auxiliary current JQ16 flows from the recovery capacitor C10 through a path in reverse direction passing through inductor L10c and switching element Q16 to ground terminal GND2 at the ground potential. Because the foregoing path through which primary auxiliary current JQ16 flows is the path charging in the reverse direction (recovery direction) to inductor L10c, it is also called the recovery charge path. Because the potential VB at the node (that is, node B) between capacitor C10 and inductor L10c is Vs/2, the primary auxiliary current JQ16 that flows at this time decreases (increases in reverse) at a slope of (Vs/2)/L where L is the inductance of inductor L10c. As a result, a reverse primary auxiliary current JQ16 flows to inductor L10c and stores reverse primary auxiliary energy in inductor L10c. Reverse secondary auxiliary energy is also stored in inductor L10a by mutual induction at the same time.

In the following period T5, the power recovery circuit 51 is operated to recover power from scan electrodes SC1 to SCn to the recovery capacitor C10. Note that switching element Q12 is turned on at time t41 before time t5 so that the secondary auxiliary current from the reverse auxiliary energy stored in inductor L10c and inductor L10a flows quickly to inductor L10a at the transition from period T4 to period T5.

### Period T5

At time t5, switching element Q13 and switching element Q16 turn off.

Because recovery inductor L10a and interelectrode capacitance Cp form a LC resonance circuit, this switching operation produces LC resonance. Based on this LC resonance, primary current flows along a reverse path from scan electrodes SC1 to SCn through inductor L10a, diode D12, and switching element Q12 to recovery capacitor C10, and primary power is recovered. This path through which the primary current flows is called the recovery path. As a result, the potential of the scan electrode drive signal S43 begins to drop at scan electrodes SC1 to SCn. For example, when the resonance period of the recovery inductor L10a and interelectrode capacitance Cp is set to approximately 3 μsec, the potential of the scan electrode drive signal S43 at scan electrodes SC1 to SCn drops to near the ground potential approximately 1 μsec after time t5. The recovery charge path shares only recovery capacitor C10 with the recovery path, and as a path is actually separated from the recovery path.

As a result of turning switching element Q16 off at time t5, the primary auxiliary current JQ16 flowing through the recovery charge path is cut off as shown in FIG. 7. As described above in period T2, the reverse primary auxiliary energy stored in inductor L10c is converted to reverse secondary auxiliary energy in inductor L10a. After time t5, as a result of the reverse discharge caused by the reverse secondary auxiliary energy stored in inductor L10a, secondary auxiliary current starts flowing along a path in the reverse direction from scan electrodes SC1 to SCn passed inductor L10a, diode D12, and switching element Q12 to recovery capacitor C10. Because it is the path of discharge in the reverse direction (recovery direction) from inductor L10a, the foregoing path of secondary auxiliary current flow is called the recovery discharge path. This secondary auxiliary current is added to the primary current that flows due to the LC resonance of the recovery inductor L10a and interelectrode capacitance Cp, and current JL10a decreases sharply (increases sharply in the reverse direction). The recovery discharge path is the same as the recovery path.

As will be known from the waveform in FIG. 7 showing the change in the current JL10a flowing to the inductor L10a, the falling edge of the current JL10a flowing from the scan electrodes SC1 to SCn is significantly sharper than only the primary current (not shown in the figure) flowing due to the LC resonance of the inductor L10a and interelectrode capacitance Cp.

The secondary auxiliary current flowing to the inductor L10a as a result of the energy in the reverse direction stored in inductor L10c being converted to the reverse direction energy of inductor L10a can be determined from the equation

Ia·Ic×Nc/Na

where Nc is the turn count of inductor L10c, Ic is the primary auxiliary current that flows, Na is the turn count of inductor L10a, and Ia is the secondary auxiliary current that flows. For example, if turn count Nc and turn count Na are equal, the secondary current Ia and primary current Ic will be equal. If turn count Nc is twice turn count Na, secondary current Ia can be made twice primary current Ic. The resonance period of the LC resonance of inductor L10a and interelectrode capacitance Cp can therefore be set using the turn count Na of inductor L10a, and the slope of the current recovered from scan electrodes SC1 to SCn to the power recovery circuit 51 when the sustain pulse falls can be set using the turn count Nc of inductor L10c.

The current flowing from the scan electrodes SC1 to SCn to the power recovery circuit 51 when the sustain pulse falls in period T5 can therefore be made to drop sharply (increase sharply in the reverse direction) using the reverse energy stored in inductor L10c in period T4, and the sustain pulse can be made to fall quickly. In addition, the peak current flowing to inductor L10a can also be suppressed.

When the power recovery circuit 51 and auxiliary circuit 53 are not used, the voltage of the scan electrode drive signal S43 applied to the scan electrodes SC1 to SCn is lowest when half of the resonance period has passed, but does not drop to the ground potential as a result of power loss, for example. However, as described above, the secondary auxiliary current resulting from the effect of the reverse primary energy stored in inductor L10c is added to the primary current that flows as a result of the LC resonance of the inductor L10a and interelectrode capacitance Cp. The voltage of the scan electrode drive signal S43 applied to scan electrodes SC1 to SCn can therefore be lowered to the ground potential in a time shorter than half the resonance period (that is, in approximately 1 μsec relative to the approximately 3 μsec resonance period).

It is therefore possible to reduce EMI and to reduce reactive power due to the drop in peak current, and the sustain discharge can be output stably by reducing ringing due to the drop in peak current. In addition, by reducing reactive power, the voltage of the scan electrode drive signal S43 applied to scan electrodes SC1 to SCn can be lowered to a potential (actually to the ground potential in this embodiment) closer to the ground potential. As a result, the power recovery efficiency of the power recovery circuit 51 can be increased, the power discharged from scan electrodes SC1 to SCn to ground terminal GND1 when switching to the immediately downstream clamping circuit 52 can be suppressed, and power consumption can be further reduced.

The auxiliary circuit 53 is configured to pass the reverse current that flows to inductor L10c to store energy in inductor L10c to ground terminal GND2 only through the minimum required circuitry (switching element Q16 in this example) without passing through unnecessary circuitry. As a result, reactive power and unnecessary heat output from switching element Q12 and diode D12 can be reduced.

### Period T6

At time t6, switching element Q14 is turned on. As a result, scan electrodes SC1 to SCn are set to the ground potential through switching element Q14.

Because the potential of the scan electrode drive signal S43 applied to scan electrodes SC1 to SCn is driven to ground (0 V) by the power recovery circuit 51, no real change in the potential of scan electrodes SC1 to SCn occurs even if scan electrodes SC1 to SCn are clamped to ground. As a result, power consumption by the clamping circuit 52 can be reduced.

Switching element Q11 may be turned off from time t3 to time t4, and switching element Q12 may be turned off from time t to the next time t1. Switching element Q13 is also preferably turned off immediately before time t5, and switching element Q14 is preferably turned off immediately before time t2, in order to lower the output impedance of sustain pulse generating circuit 50.

The operation described above in period T1 to period T6 is repeated in the sustain period according to the number of required pulses. As a result, the sustain pulse voltage that changes from the reference potential (0 V) to potential Vs is alternately applied to each of the display electrode pairs 24 so that the discharge cells output a sustain discharge.

As described above, by using the auxiliary circuit 53 in a plasma display device according to the first embodiment of the invention, the auxiliary current produced by energy previously stored in inductor L10b and inductor L10c can be added to the primary current flow produced by LC resonance at the pulse edges when the sustain pulse rises and falls. As a result, the level of the current JL10a flowing between the sustain pulse generating circuit 50 and interelectrode capacitance Cp can be quickly increased. A sufficient sustain pulse clamping period can therefore be assured when the sustain pulse period is shortened due to increased panel definition, and the peak current flowing between the inductor L10a and interelectrode capacitance Cp can be reduced by increasing the resonance period of the recovery inductor L10a and interelectrode capacitance Cp. Therefore, a stable sustain discharge can be produced by assuring a sufficient clamping period, and power consumption and EMI can be reduced by reducing the peak current, in a high definition panel.

Furthermore, while the resonance period of the recovery inductor L10a and interelectrode capacitance Cp must be set to approximately 2 μsec in order to produce a stable sustain discharge in a sustain pulse generating circuit that does not use a power recovery circuit 51 and auxiliary circuit 53, this first embodiment of the invention can produce a stable sustain discharge even if the resonance period is increased to approximately 3 μsec. In addition, the peak current can be reduced approximately 38% by increasing the resonance period from 2 μsec to 3 μsec.

Furthermore, because the primary auxiliary current that flows to inductor L10b and inductor L10c in order to store primary auxiliary energy in inductor L10b and inductor L10c is passed through the shortest possible path (specifically a forward auxiliary switch when storing forward primary auxiliary energy, and a reverse auxiliary switch when storing reverse primary auxiliary energy) without passing through unnecessary circuits, unnecessary heat output and reactive power can be reduced.

### Embodiment 2

A second embodiment of the invention is described next with particular attention to how it differs from the first embodiment. Other aspects of the configuration, operation, and effect of this embodiment are identical to the first embodiment, and further description thereof is omitted.

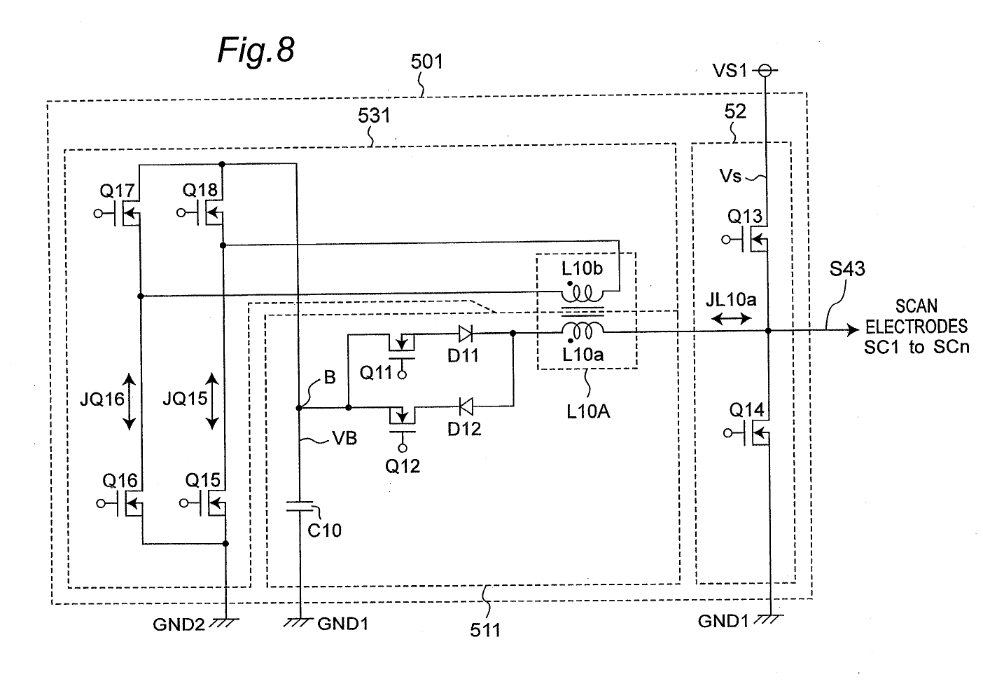

FIG. 8 is a circuit diagram of the sustain pulse generating circuit 501 in this embodiment of the invention. This sustain pulse generating circuit 501 has a power recovery circuit 511, clamping circuit 52, and auxiliary circuit 531. This sustain pulse generating circuit 501 differs from the sustain pulse generating circuit 50 in the first embodiment in that the configuration of the mutual inductor L10A differs from the mutual inductor L10 in the first embodiment, and switching element Q17 and switching element Q18 are added.

Auxiliary circuit 531 includes switching element Q15, switching element Q16, switching element Q17, switching element Q18, and inductor L10b. The mutual inductor L10A includes inductor L10a and inductor L10b, but does not include inductor L10c.

Inductor L10b forms an auxiliary induction unit.

Inductor L10a is coupled by mutual induction to inductor L10b, and forms a primary induction unit.

One terminal of inductor L10b is connected to a node between switching element Q16 and switching element Q17, and the other terminal of inductor L10b is connected to a node between switching element Q15 and switching element Q18. The other terminal of switching element Q16 and the other terminal of switching element Q15 are both connected to ground terminal GND2 and go to ground, and the other terminal of switching element Q17 and the other terminal of switching element Q18 are connected to recovery capacitor C10 (that is, to node B), and are set to potential VB (.Vs/2).

Switching element Q15 and switching element Q17 operate in the same way as switching element Q15 in the first embodiment (shown in FIG. 7), and switching element Q16 and switching element Q18 operate in the same way as switching element Q16 in the first embodiment (shown in FIG. 7). More specifically, auxiliary circuit 531 energizes switching element Q15 and switching element Q17 in period T1, and stores forward primary auxiliary energy in inductor L10b. In addition, in period T4, auxiliary circuit 531 energizes switching element Q16 and switching element Q18, and stores reverse primary auxiliary energy in inductor L10b.

As in the first embodiment, by using the auxiliary circuit 531 in a plasma display device according to the second embodiment of the invention, the secondary auxiliary current produced by the primary auxiliary energy previously stored in inductor L10b can be added to the primary current flow produced by LC resonance at the pulse edges when the sustain pulse rises and falls. As a result, the level of the current JL10a flowing between the sustain pulse generating circuit 501 and interelectrode capacitance Cp can be quickly increased. A sufficient sustain pulse clamping period can therefore be assured when the sustain pulse period is shortened due to increased panel definition, and the peak current flowing between the recovery inductor L10a and interelectrode capacitance Cp can be reduced by increasing the resonance period of the recovery inductor L10a and interelectrode capacitance Cp. Therefore, a stable sustain discharge can be produced by assuring a sufficient clamping period, and power consumption and EMI can be reduced by reducing the peak current, in a high definition panel.

In addition, the auxiliary induction unit is formed by only inductor L10b, and the configuration of the switching element in the auxiliary circuit 531 is changed from the configuration used in auxiliary circuit 53, so that the sustain pulse generating circuit 501 can be operated in the same way as the sustain pulse generating circuit 50 in the first embodiment. As a result, the overall size of the mutual inductor L10A can be reduced because the number of windings in the mutual inductor L10A can be reduced and the size of the magnetic core can be reduced.

### Embodiment 3

A third embodiment of the invention is described next with particular attention to how it differs from the first embodiment. Other aspects of the configuration, operation, and effect of this embodiment are identical to the first embodiment, and further description thereof is omitted.

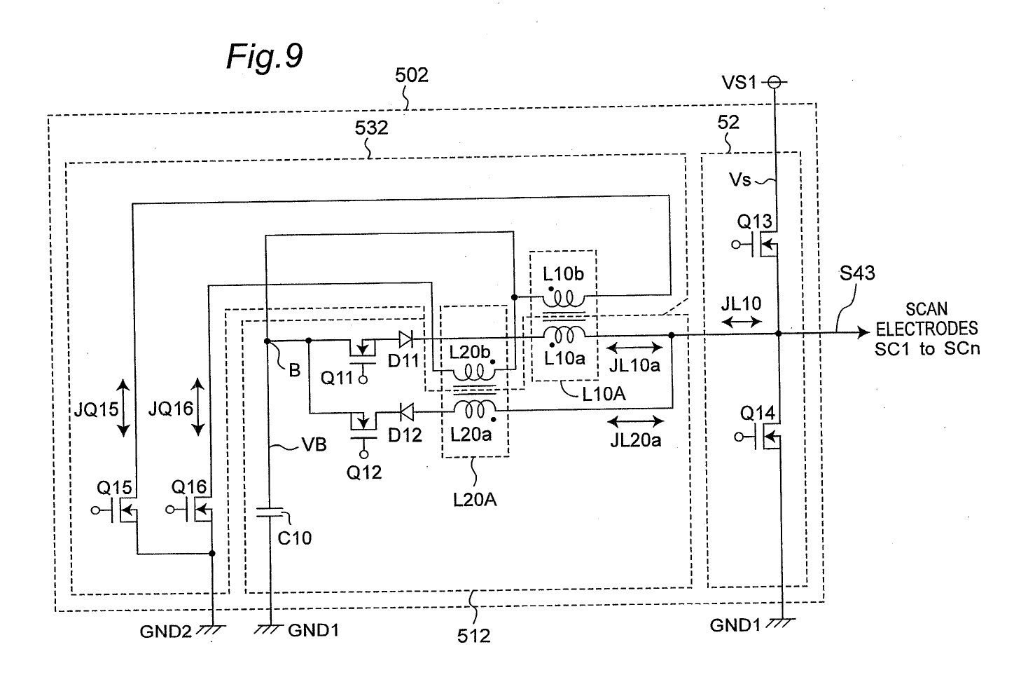

FIG. 9 is a circuit diagram of the sustain pulse generating circuit 502. The sustain pulse generating circuit 502 includes a power recovery circuit 512, clamping circuit 52, and auxiliary circuit 532. The sustain pulse generating circuit 502 differs from the sustain pulse generating circuit 50 of the first embodiment in that the mutual inductor L10 of the first embodiment is changed to mutual inductor L10A and mutual inductor L20A.

The power recovery circuit 512 has a capacitor C10, switching element Q11, switching element Q12, diode D11, diode D12, inductor L10a, and inductor L20a.

The auxiliary circuit 532 has a switching element Q15, switching element Q16, inductor L10b, and inductor L20b.

The mutual inductor L10A includes inductor L10a and inductor L10b, and mutual inductor L20A includes inductor L20a and inductor L20b. Inductor L10b and inductor L20b form an auxiliary induction unit. Inductor L10a and inductor L20a are respectively coupled by mutual induction to inductor L10b and inductor L20b, and form a primary induction unit. More specifically, inductor L10a and inductor L20a are recovery inductors for LC resonance with the interelectrode capacitance Cp. Each inductor L10b, L20b is an example of a secondary auxiliary induction unit, and each inductor L10a, L20a is an example of a secondary primary induction unit.

Inductor L10a is a recovery inductor that is used when supplying power from the recovery capacitor C10 to the interelectrode capacitance Cp, and inductor L20a is a recovery inductor that is used when recovering power from the interelectrode capacitance Cp to the recovery capacitor C10. The power recovery circuit 512 is thus configured to use two different recovery inductors L10a and L20a for supplying power from the recovery capacitor C10 to the interelectrode capacitance Cp, and recovering power from the interelectrode capacitance Cp to the recovery capacitor C10.

The capacitor C10 and one terminal of the inductor L10a are connected in series with the serially connected switching element Q11 and diode D11 therebetween.

In addition, capacitor C10 and one terminal of the inductor L20a are connected in series with the serially connected switching element Q12 and diode D12 therebetween.

The other terminal of inductor L10a and the other terminal of inductor L20a are both connected to scan electrodes SC1 to SCn. One terminal of inductor L10b and one terminal of inductor L20b are both connected to recovery capacitor C10 (that is, node B), and are set to potential VB (.Vs/2). The other terminal of inductor L10b is connected to one terminal of switching element Q15, and the other terminal of inductor L20b is connected to one terminal of switching element Q16. The other terminal of switching element Q15 and the other terminal of switching element Q16 are both connected to ground terminal GND2, and are set to ground.

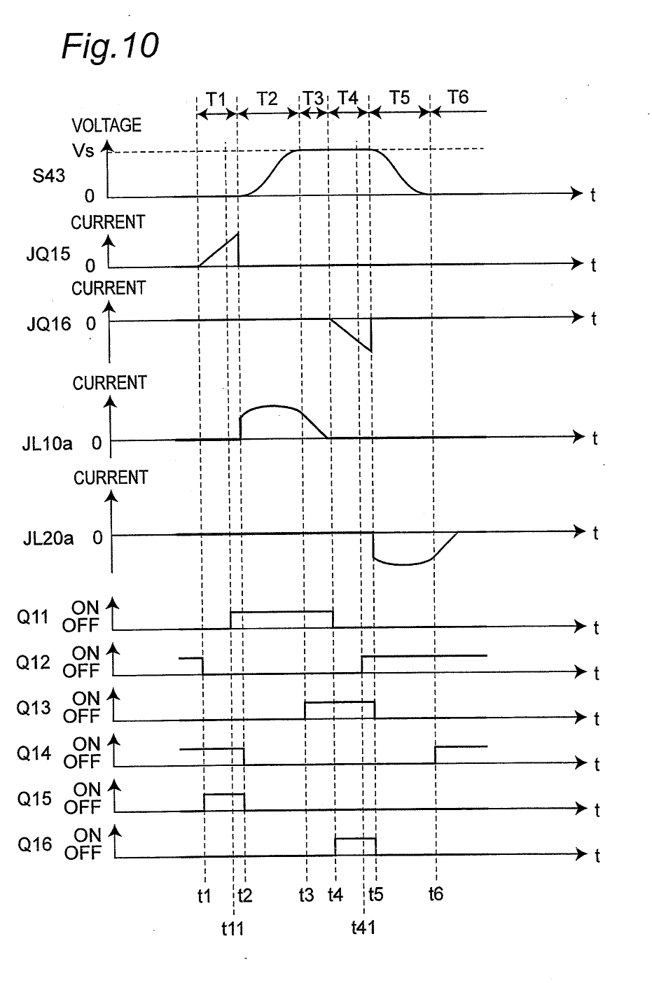

FIG. 10 is a timing chart describing the operation of the sustain pulse generating circuit 502. Except for the waveform of current JL10a, the operation of the sustain pulse generating circuit 502 is the same as the operation described with reference to the timing chart shown in FIG. 7 for the first embodiment. In this third embodiment of the invention the current JL10a flowing through inductor L10a is the same as the waveform of the current JL10a in FIG. 7 with the negative portion thereof following time t5 held at 0 A. Likewise, the current JL20a flowing through inductor L20a is the same as the current JL10a shown in FIG. 7 with the positive portion thereof from time t2 to time t4 held at 0 A.

More specifically, in the first embodiment of the invention a positive current JL10a is supplied to the inductor L10a when supplying power to scan electrodes SC1 to SCn, and a negative current JL10a flows at inductor L10a in the same way as when recovering power from the scan electrodes SC1 to SCn.

In this third embodiment, however, a positive current JL10a flows at inductor L10a when supplying power to the scan electrodes SC1 to SCn, and a negative current JL20a flows at inductor L20a when recovering power from the scan electrodes SC1 to SCn.

As in the first embodiment, by using the auxiliary circuit 532 in a plasma display device according to the third embodiment of the invention, the secondary auxiliary current produced by the primary auxiliary energy previously stored in inductor L10b and inductor L20b can be added to the primary current flow produced by LC resonance at the pulse edges when the sustain pulse rises and falls. As a result, the level of the current JL10 flowing between the sustain pulse generating circuit 502 and interelectrode capacitance Cp can be quickly increased. A sufficient sustain pulse clamping period can therefore be assured when the sustain pulse period is shortened due to increased panel definition, and the peak current flowing between the recovery inductors L10a and L20a and interelectrode capacitance Cp can be reduced by increasing the resonance period of the recovery inductors L10a and L20a and interelectrode capacitance Cp. Therefore, a stable sustain discharge can be produced by assuring a sufficient clamping period, and power consumption and EMI can be reduced by reducing the peak current, in a high definition panel.

In addition, because the recovery inductor is configured using inductor L10a and a separte inductor L20a in this third embodiment of the invention, current control at the rise of the sustain pulse can be configured separately from current control at the fall of the sustain pulse. Different resonance periods can therefore be used when supplying power and when recovering power.

### Embodiment 4

A fourth embodiment of the invention is described next with particular attention to how it differs from the first embodiment. Other aspects of the configuration, operation, and effect of this embodiment are identical to the first embodiment, and further description thereof is omitted.

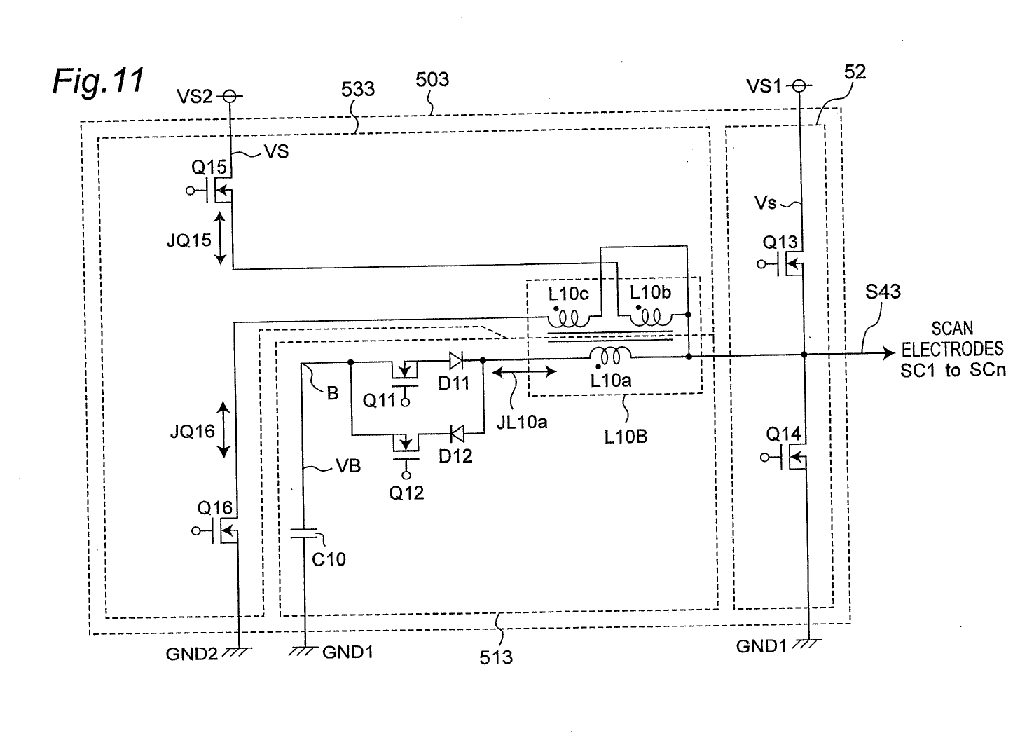

FIG. 11 is a circuit diagram of the sustain pulse generating circuit 503. The sustain pulse generating circuit 503 includes a power recovery circuit 513, clamping circuit 52, and auxiliary circuit 533. The sustain pulse generating circuit 503 differs from the sustain pulse generating circuit 50 of the first embodiment in that how the mutual inductor L10B is connected differs from in the first embodiment, and how the switching element Q15 is connected differs from in the first embodiment.

Power source VS2 supplies potential Vs and the reference potential (such as the ground potential) to the auxiliary circuit 533. From a different perspective, power source VS2 supplies potential Vs and the reference power supply GND2 supplies the reference potential to the auxiliary circuit 533.

The auxiliary circuit 533 includes switching element Q15, switching element Q16, inductor L10b, and inductor L10c. Switching element Q15 is a forward auxiliary switch that is energized when supplying current forward to the inductor L10b. Switching element Q16 is a reverse auxiliary switch that is energized when supplying current in reverse to the inductor L10c. One terminal of switching element Q15 is connected to one terminal of inductor L10b, and the other terminal of switching element Q15 is connected to power source VS2 and set to potential Vs. One terminal of switching element Q16 is connected to one terminal of inductor L10c, and the other terminal of switching element Q16 is connected to ground terminal GND2 and goes to ground, which is the reference potential. The other terminal of inductor L10b and the other terminal of inductor L10c are both connected to scan electrodes SC1 to SCn.

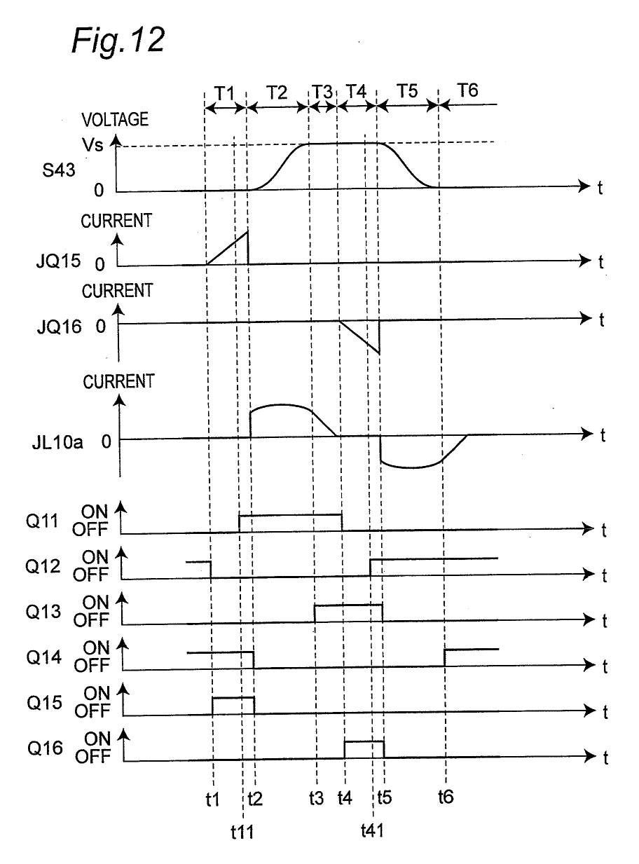

FIG. 12 is a timing chart describing the operation of the sustain pulse generating circuit 503.

### Period T1

At time t1 switching element Q15 is turned on. During this period switching element Q14 is held on, and scan electrodes SC1 to SCn are clamped to 0 (V). As a result, primary auxiliary current JQ15 flows from power source VS2 along a path passed switching element Q15, inductor L10b, and switching element Q14 and to ground terminal GND1, which is at the reference potential. This path through which the primary auxiliary current JQ15 flows is also called the supply charge path because it is the path for charging in the forward direction (supply direction) to inductor L10b. Because the primary auxiliary current JQ15 that flows at this time is a current flowing through the inductor L10b between potential Vs and the ground potential, the current increases at a slope of Vs/L where L is the inductance of inductor L10b. As a result, primary auxiliary current JQ15 is supplied forward to the inductor L10b, and forward primary auxiliary energy is stored in inductor L10b. Forward secondary auxiliary energy is also stored at the same time in inductor L10a by mutual induction.

Switching element Q11 is turned on at time t11 before time t2 so that the secondary auxiliary current produced by the forward auxiliary energy stored in inductor L10b and inductor L10a flows quickly to inductor L10a at the transition from period T1 to period T2.

### Period T2

At time t2, switching element Q14 and switching element Q15 are turned off.

Because recovery inductor L10a and interelectrode capacitance Cp form a LC resonance circuit, LC resonance is produced by this switching operation. Based on this LC resonance, primary current flows and the primary power is supplied through the forward path from recovery capacitor C10 through switching element Q11, diode D11, and inductor L10a, and to scan electrodes SC1 to SCn. This path through which the primary current flows is also called the supply path. As a result, the potential of scan electrode drive signal S43 begins to rise at scan electrodes SC1 to SCn. The supply charge path shares lines with the supply path only in part, and does not share any functional devices contained on the path. (As further described below, there are also configurations that do share lines or functional devices on the path.)

When switching element Q14 and switching element Q15 turn off at time t2, the primary auxiliary current JQ15 flowing through the supply charge path is cut off as shown in FIG. 12. At this time inductor L10b and inductor L10a stop the forward auxiliary energy charging operation from power source VS2 and start the discharge operation. Because the path through inductor L10b is cut off, discharge starts on a path through inductor L10a, and secondary auxiliary current flows at inductor L10a. The auxiliary energy stored in inductor L10b and inductor L10a does not change before and after time t2. As a result, the secondary auxiliary current flowing through inductor L10a is substantially equal to the turn ratio of inductor L10b to inductor L10a multiplied by the primary auxiliary current JQ15 that was flowing to the inductor L10b immediately before being cut off. The forward primary auxiliary energy stored in the inductor L10b is thus converted to forward secondary auxiliary current at inductor L10a. After time t2, secondary auxiliary current starts flowing along the forward path from the recovery capacitor C10 passed switching element Q11, diode D11, and inductor L10a to the scan electrodes SC1 to SCn as a result of the forward discharge resulting from the forward secondary auxiliary energy stored in inductor L10a.

Because this path through which the secondary auxiliary current flows is a path of discharge in the forward (supply) direction from inductor L10a, it is also called the supply discharge path. This secondary auxiliary current is added to the primary current that flows due to the LC resonance between inductor L10a and interelectrode capacitance Cp, and current JL10a rises rapidly forward. The supply discharge path is the same as the supply path.

As a result, the rise in current JL10a flowing to the scan electrodes SC1 to SCn is significantly sharper than only the primary current (not shown in the figure) resulting from the LC resonance of the recovery inductor L10a and interelectrode capacitance Cp as indicated by the waveform showing the change in current JL10a flowing to the inductor L10a in FIG. 12.

### Period T3

The operation in period T3 is the same as described above with reference to FIG. 7, and further description thereof is omitted.

### Period T4

At time t4 switching element Q16 is turned on. As a result, primary auxiliary current JQ16 flows from the power source VS1 through a path in reverse direction passing through switching element Q13, inductor L10c and switching element Q16 to ground terminal GND2 at the ground potential. Because the foregoing path through which primary auxiliary current JQ16 flows is the path charging in the reverse direction (recovery direction) to inductor L10c, it is also called the recovery charge path. Because the primary auxiliary current JQ16 that flows at this time is a current that flows through inductor L10c between potential Vs and the ground potential, the primary auxiliary current JQ16 decreases at a slope of Vs/L (increases in reverse) where L is the inductance of the inductor L10c. As a result, primary auxiliary current JQ16 flows in reverse to the inductor L10c and primary auxiliary energy is stored in reverse in the inductor L10c. Reverse secondary auxiliary energy is also stored in inductor L10a by mutual induction at the same time.

Switching element Q12 is turned on at time t41 before time t5 so that the secondary auxiliary current from the reverse auxiliary energy stored in inductor L10c and inductor L10a flows quickly to inductor L10a at the transition from period T4 to period T5.

### Period T5

At time t5, switching element Q13 and switching element Q16 turn off.

Because recovery inductor L10a and interelectrode capacitance Cp form a LC resonance circuit, this switching operation produces LC resonance. Based on this LC resonance, primary current flows along a reverse path from scan electrodes SC1 to SCn through inductor L10a, diode D12, and switching element Q12 to recovery capacitor C10, and primary power is recovered. This path through which the primary current flows is called the recovery path. As a result, the potential of the scan electrode drive signal S43 begins to drop at scan electrodes SC1 to SCn. The recovery charge path intersects with the recovery path only in part, and as a path is actually separated from the recovery path. The recovery charge path shares only some lines with the recovery path, and does not share any functional devices included along the path. In addition, the recovery charge path is separate from the recovery path. (As further described below, configurations that do not share functional devices on the path or lines are also conceivable.)

As a result of turning switching element Q13 and switching element Q16 off at time t5, the primary auxiliary current JQ16 flowing through the recovery charge path is cut off as shown in FIG. 12. As described above in period T2, the reverse primary auxiliary energy stored in inductor L10c is converted to reverse secondary auxiliary energy in inductor L10a. After time t5, as a result of the reverse discharge caused by the reverse secondary auxiliary energy stored in inductor L10a, secondary auxiliary current starts flowing along a path in the reverse direction from scan electrodes SC1 to SCn passed inductor L10a, diode D12, and switching element Q12 to recovery capacitor C10. Because it is the path of discharge in the reverse direction (recovery direction) from inductor L10a, the foregoing path of secondary auxiliary current flow is called the recovery discharge path. This secondary auxiliary current is added to the primary current that flows due to the LC resonance of the recovery inductor L10a and interelectrode capacitance Cp, and current JL10a decreases sharply (increases sharply in the reverse direction). The recovery discharge path is the same as the recovery path.

As will be known from the waveform in FIG. 7 showing the change in the current JL10a flowing to the inductor L10a, the falling edge of the current JL10a flowing from the scan electrodes SC1 to SCn is significantly sharper than only the primary current (not shown in the figure) flowing due to the LC resonance of the inductor L10a and interelectrode capacitance Cp.

### Period T6

The operation in period T6 is the same as described above with reference to FIG. 7, and further description thereof is omitted.

As in the first embodiment and described above, by using the auxiliary circuit 533 in a plasma display device according to the fourth embodiment of the invention, the auxiliary current produced by energy previously stored in inductor L10b and inductor L10c can be added to the primary current flow produced by LC resonance at the pulse edges when the sustain pulse rises and falls. As a result, the level of the current JL10a flowing between the sustain pulse generating circuit 503 and interelectrode capacitance Cp can be quickly increased. A sufficient sustain pulse clamping period can therefore be assured when the sustain pulse period is shortened due to increased panel definition, and the peak current flowing between the inductor L10a and interelectrode capacitance Cp can be reduced by increasing the resonance period of the recovery inductor L10a and interelectrode capacitance Cp. Therefore, a stable sustain discharge can be produced by assuring a sufficient clamping period, and power consumption and EMI can be reduced by reducing the peak current, in a high definition panel.

Furthermore, as in the first embodiment, because the primary auxiliary current that flows to inductor L10b and inductor L10c in order to store primary auxiliary energy in inductor L10b and inductor L10c is passed through the shortest possible path (specifically a forward auxiliary switch and a switch on the ground potential side of the clamping circuit when storing forward primary auxiliary energy, and a reverse auxiliary switch and a switch on the power supply side of the clamping circuit when storing reverse auxiliary energy) without passing through unnecessary circuits, unnecessary heat output and reactive power can be reduced.

Yet further, period T1 and period T4 can be shortened in this fourth embodiment of the invention because when primary auxiliary current is supplied to the inductor L10b and inductor L10c, the slope of the increase can be made approximately twice as sharp as in the first embodiment.

It should be noted that in this fourth embodiment the node between the inductor L10b and inductor L10c is connected to scan electrodes SC1 to SCn, is connected to power source VS1 through switching element Q13 using the clamping circuit 52, and is connected to ground terminal GND1 through switching element Q14. However, the node between inductor L10b and inductor L10c may be connected to power source VS2 through an additional switching element without being connected to inductor L10a, and may be connected to ground terminal GND2 through a separate additional switching element.

### Embodiment 5

A fifth embodiment of the invention is described next with particular attention to how it differs from the first embodiment. Other aspects of the configuration, operation, and effect of this embodiment are identical to the first embodiment, and further description thereof is omitted.

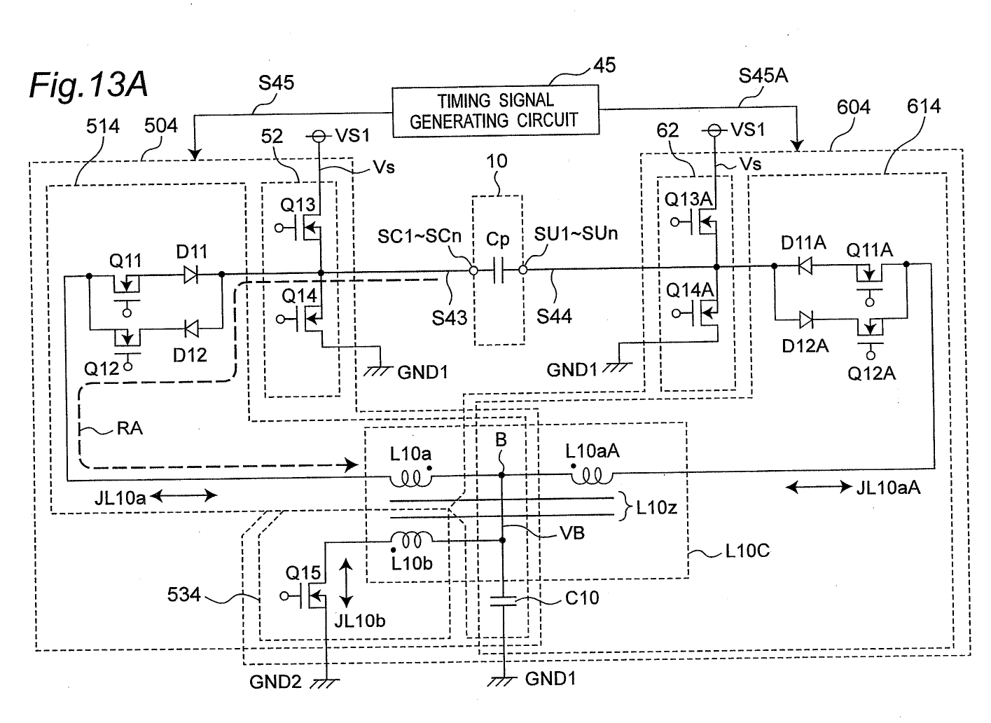

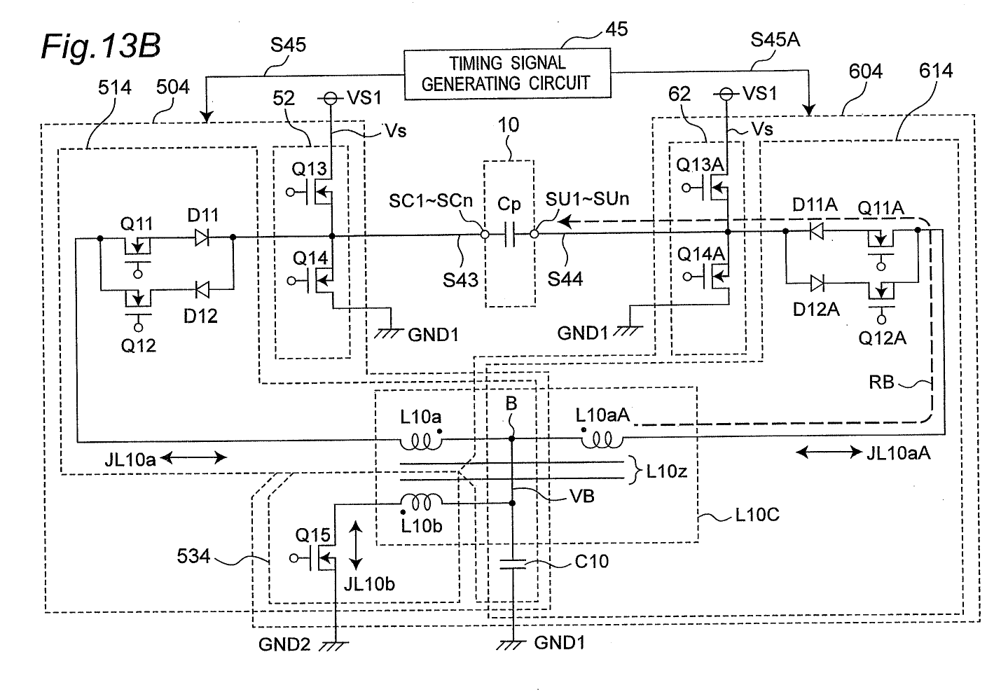

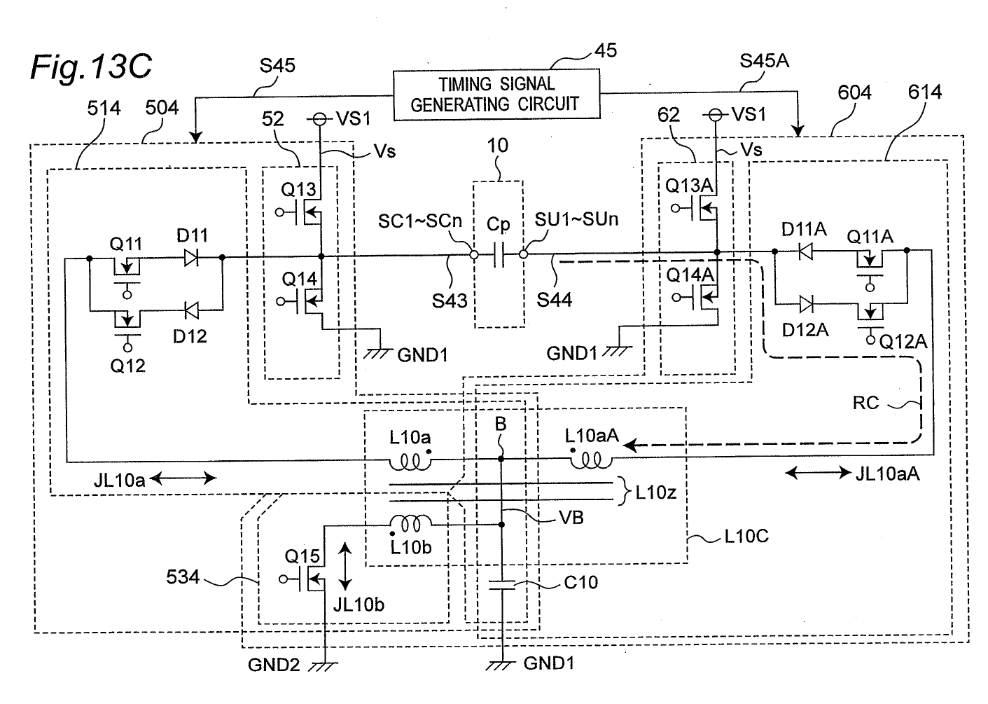

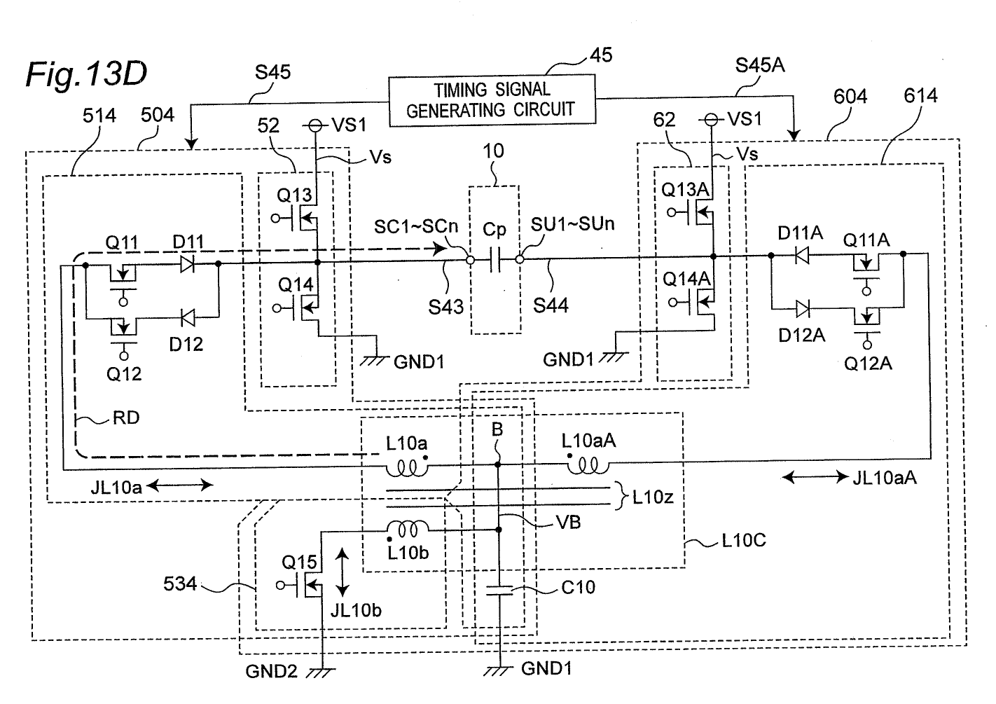

FIG. 13A, FIG. 13B, FIG. 13C, and FIG. 13D are circuit diagrams of the scan electrode sustain pulse generating circuit 504 (also simply referred to as the sustain pulse generating circuit 504) and sustain electrode sustain pulse generating circuit 604 (also simply referred to as the sustain pulse generating circuit 604). The sustain pulse generating circuit 50 of the first embodiment is changed to sustain pulse generating circuit 504, and the sustain pulse generating circuit 60 of the first embodiment is changed to the sustain pulse generating circuit 604.

More specifically, the sustain pulse generating circuit 504 generates the scan electrode drive signal S43 based on a timing signal S45 from the timing signal generating circuit 45, and drives the scan electrodes SC1 to SCn.

The sustain pulse generating circuit 604 generates a sustain electrode drive signal S44 based on timing signals S45A from the timing signal generating circuit 45, and drives the sustain electrodes SU1 to SUn.

The sustain pulse generating circuit 504 includes a power recovery circuit 514, clamping circuit 52, and auxiliary circuit 534.

The sustain pulse generating circuit 604 includes a power recovery circuit 614, clamping circuit 62, and auxiliary circuit 534.

The sustain pulse generating circuit 504 and sustain pulse generating circuit 604 share auxiliary circuit 534.

The power recovery circuit 514 includes a recovery capacitor C10, switching element Q11, switching element Q12, diode D11, diode D12, and recovery inductor L10a. Switching element Q11 is energized when supplying power from the recovery capacitor C10 to the scan electrodes SC1 to SCn. Switching element Q12 is energized when recovering power from the scan electrodes SC1 to SCn to the recovery capacitor C10. The diode D11 stops current backflow when supplying current forward from the recovery capacitor C10 to the scan electrodes SC1 to SCn. Diode D12 prevents current backflow during forward power recovery from the scan electrodes SC1 to SCn to the recovery capacitor C10.

The power recovery circuit 614 includes a recovery capacitor C10, switching element Q11A, switching element Q12A, diode D11A, diode D12A, and recovery inductor L10aA. Switching element Q11A is energized when supplying power from the recovery capacitor C10 to the sustain electrodes SU1 to SUn. Switching element Q12A is energized during power recovery from the sustain electrodes SU1 to SUn to the recovery capacitor C10. Diode D11A prevents current backflow when supplying power forward from the recovery capacitor C10 to the sustain electrodes SU1 to SUn. Diode D12A prevents current backflow when recovering power forward from the sustain electrodes SU1 to SUn to the recovery capacitor C10. Power recovery circuit 514 and power recovery circuit 614 share recovery capacitor C10.

The auxiliary circuit 534 includes switching element Q15 and auxiliary inductor L10b. Switching element Q15 is an auxiliary switch that is energized when supplying current JL10b to the auxiliary inductor L10b.

One terminal of recovery capacitor C10 is connected to ground terminal GND1 and is set to the ground potential, which is the reference potential, and the other terminal (that is, node B) is set to potential VB (=Vs/2).

The serially connected switching element Q11 and diode D11 are parallel connected to serially connected switching element Q12 and diode D12 parallel so that current flows in opposite directions through each switching element and diode pair. One terminal of this parallel circuit is connected through the recovery inductor L10a to the other terminal (that is, node B) of the recovery capacitor C10, and the other terminal is connected to scan electrodes SC1 to SCn.

Likewise, the serially connected switching element Q11A and diode D11A are parallel connected to the serially connected switching element Q12A and diode D12A so that current flows in opposite directions through each switching element and diode pair. One terminal of this parallel circuit is connected through the recovery inductor L10a to the other terminal (that is, node B) of the recovery capacitor C10, and the other terminal is connected to sustain electrodes SU1 to SUn.

One terminal of switching element Q15 is connected to the other terminal (that is, node B) of recovery capacitor C10 through inductor L10b, and the other terminal is connected to ground terminal GND2 and set to the reference potential.

Recovery inductor L10a, recovery inductor L10aA, and auxiliary inductor L10b form a mutual inductor L10C. The recovery inductor L10a, recovery inductor L10aA, and auxiliary inductor L10b each include at least a part of magnetic core L10z, and have a predetermined self-inductance due to self induction.

In addition, recovery inductor L10a, recovery inductor L10aA, and auxiliary inductor L10b are magnetically coupled by mutual induction through the magnetic core L10z, and have a predetermined mutual inductance. The sign of the mutual inductance is determined by the structure of the magnetic core L10z that produces the mutual induction, and the direction of the coil windings of the inductors L10a, L10aA, and L10b. In FIG. 13A to FIG. 13D, mutual inductor L10C is configured using a pole-shaped magnetic core L10z with the coil of recovery inductor L10a and the coil of inductor L10aA each winding in the opposite direction as the coil winding of the auxiliary inductor L10b. More specifically, inductor L10a and inductor L10aA are mutually coupled by positive mutual induction. Inductor L10b is coupled by negative mutual induction to inductor L10a, and to inductor L10aA by negative mutual induction. For example, the number of turns of inductor L10b is greater than or equal to the number of turns of inductor L10a, and the number of turns of inductor L10aA is substantially equal to the number of turns of inductor L10a.

Note, further, that the configuration of the mutual inductor L10C is not limited to the configurations shown in FIG. 13A to FIG. 13D, and may, for example, have a toroidal magnetic core with the winding direction of each coil changing as needed to achieve the same operation as the configuration described in FIG. 13A to FIG. 13D.

In the first to fourth embodiments the recovery inductor included in the scan electrode drive circuit 43 and the recovery inductor included in the sustain electrode drive circuit 44 have mutually different magnetic cores, and the mutual induction therebetween is substantially zero. In the case of mutual inductor L10C, however, recovery inductors L10a and L10aA share magnetic core L10z, and are formed by winding the coil around the magnetic core L10z. More specifically, the scan electrode drive circuit 43 and sustain electrode drive circuit 44 share a recovery inductor formed by inductor L10a and inductor L10aA.

As a result of reverse primary auxiliary current JL10b flowing in the direction from the recovery capacitor C10 to the switching element Q15 at inductor L10b, current JL10a flows in the reverse direction to recovery inductor L10a and current JL10aA flows in the reverse direction to recovery inductor L10aA.

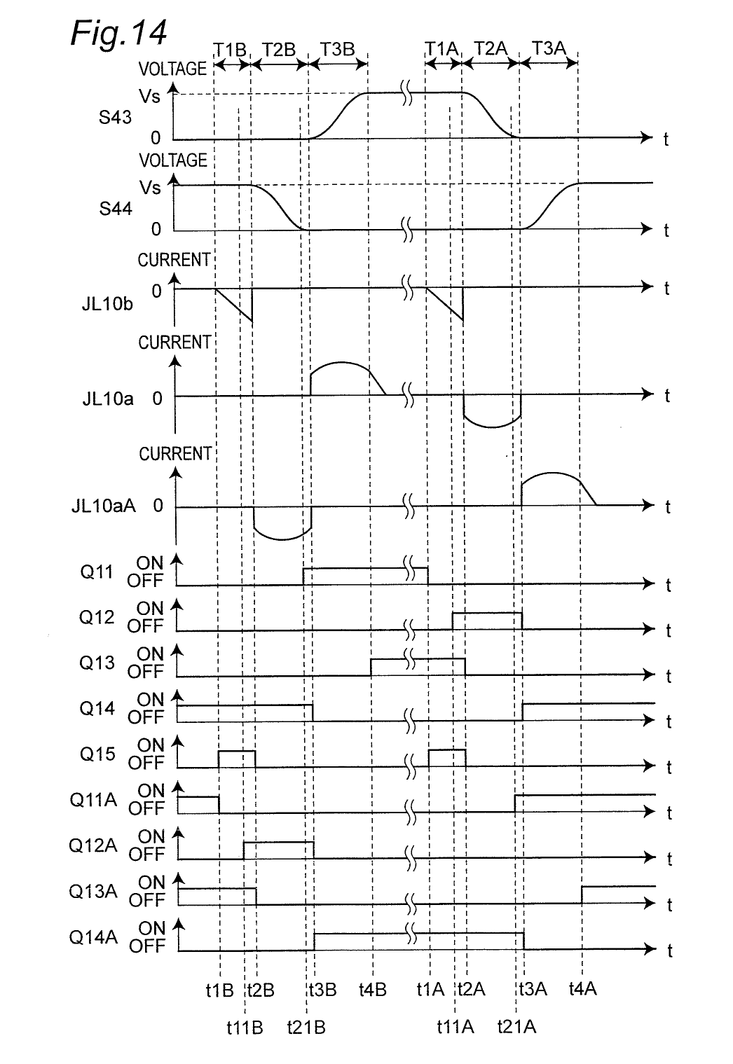

FIG. 14 is a timing chart describing the operation of the sustain pulse generating circuit.

In order from the top in FIG. 14, S43 shows the change in the voltage of the scan electrode drive signal S43 applied to scan electrodes SC1 to SCn.

S44 shows the change in the voltage of the sustain electrode drive signal S44 applied to the sustain electrodes SU1 to SUn.

JI10b shows the change in the current JL10b flowing from inductor L10b to switching element Q15 (note that in this example the direction of flow from inductor L10b to switching element Q15 is negative).

JI10a shows the change in the current JL10a flowing to the inductor L10a.

JL10aA shows change in the current JL10aA flowing to the inductor L10aA (note that the direction of flow from capacitor C10 to inductor L10a and inductor L10aA is positive, and the direction of flow from inductor L10a and inductor L10aA to capacitor C10 is negative).

Q11 denotes the control state of switching element Q11.

Q12 denotes the control state of switching element Q12.

Q13 denotes the control state of switching element Q13.

Q14 denotes the control state of switching element Q14.

Q15 denotes the control state of switching element Q15.

Q11A denotes the control state of switching element Q11A.

Q12A denotes the control state of switching element Q12A.

Q13A denotes the control state of switching element Q13A.

Q14A denotes the control state of switching element Q14A.

In the first to fourth embodiments the frequency of the sustain pulse is set to 100 kHz, the time spent on the rising and falling edges of the sustain pulse is 1 μsec each, and the time that the sustain pulse is clamped to potential Vs is 3 μsec. In this configuration, the duty ratio of the sustain pulse is approximately (1+3)/10=40. Therefore, as shown in FIG. 14, the sustain electrode drive signal S44 rises after the scan electrode drive signal S43 falls, and the scan electrode drive signal S43 rises after the sustain electrode drive signal S44 falls. The relationship between the scan electrode drive signal S43 and sustain electrode drive signal S44 is the same in the fifth embodiment of the invention, but the foregoing values of the sustain pulse may be varied as desired insofar as this relationship is maintained.

### Period T1A

At time t1A switching element Q15 turns on. As a result, primary auxiliary current JL10b flows from recovery capacitor C10 through inductor L10b and switching element Q15 along a path in the negative direction to ground terminal GND2, which goes to ground. This path through which primary auxiliary current JL10b flows is also called the recovery charge path. The absolute value of the primary auxiliary current JL10b increases at a slope of (Vs/2)/L where L is the inductance of inductor L10b. As a result, a negative primary auxiliary current JL10b flows to inductor L10b, and negative primary auxiliary energy is stored in inductor L10b. Negative secondary auxiliary energy is also stored at the same time in inductor L10a by mutual induction.

In the following period T2A, the power recovery circuit 514 is operated to recover power from scan electrodes SC1 to SCn to recovery capacitor C10. Note that switching element Q12 is turned before time t2A at time t11A so that the secondary auxiliary current produced by the negative auxiliary energy stored in inductor L10b and inductor L10a quickly flows to inductor L10a at the transition from period T1A to period T2A.

During this period switching element Q13 is held on and scan electrodes SC1 to SCn are clamped to 0 (V).

### Period T2A

At time t2A, switching element Q13 and switching element Q15 are turned off.

Because recovery inductor L10a and interelectrode capacitance Cp form a LC resonance circuit, LC resonance is produced by this switching operation. Based on this LC resonance, primary current flows and the primary power is supplied through the reverse path from scan electrodes SC1 to SCn through diode D12, switching element Q12, and inductor L10a to the recovery capacitor C10 (FIG. 13A). This primary current is also called the scan electrode side primary current, and the primary power producing the scan electrode side primary current is also called the scan electrode side primary power. The foregoing path RA through which the scan electrode side primary current flows is the path for recovering scan electrode side primary power, and is also called the scan electrode side recovery path. As a result, the potential of the scan electrode drive signal S43 begins to drop at the scan electrodes SC1 to SCn. The recovery charge path only shares the recovery capacitor C10 with the scan electrode side recovery path, and as a path is separated from the scan electrode side recovery path.

As a result of switching element Q13 and switching element Q15 turning off at time t2A, the primary auxiliary current JL10b flowing through the recovery charge path is cut off as shown in FIG. 14. At this time inductor L10b and inductor L10a stop charging the reverse auxiliary energy from capacitor C10 and start the discharge operation. Because the path through inductor L10b is cut off, discharge starts on a path through inductor L10a, and secondary auxiliary current flows at inductor L10a. The auxiliary energy stored in inductor L10b and inductor L10a does not change before and after time t2A. As a result, the secondary auxiliary current flowing through inductor L10a is substantially equal to the turn ratio of inductor L10b to inductor L10a multiplied by the primary auxiliary current JL10a that was flowing to the inductor L10b immediately before being cut off as described in further detail below. The reverse primary auxiliary energy stored in the inductor L10b is thus converted to reverse secondary auxiliary current at inductor L10a. After time t2A, secondary auxiliary current starts flowing along the reverse path from the scan electrodes SC1 to SCn through diode D12, switching element Q12, and inductor L10a to the recovery capacitor C10 as a result of the reverse discharge resulting from the negative secondary auxiliary energy stored in inductor L10a.

This path through which the secondary auxiliary current flows is also called the scan electrode side recovery discharge path. This secondary auxiliary current is added to the scan electrode side primary current that flows due to the LC resonance between inductor L10a and interelectrode capacitance Cp, and current JL10a rises rapidly in reverse. The scan electrode side recovery discharge path is the same as scan electrode side recovery path.

As a result, the fall in current JL10a flowing from the scan electrodes SC1 to SCn is significantly sharper than only the scan electrode side primary current (not shown in the figure) resulting from the LC resonance of the recovery inductor L10a and interelectrode capacitance Cp as indicated by the waveform showing the change in current JL10a flowing to the inductor L10a in FIG. 14.

Current flow from the scan electrodes SC1 to SCn to the power recovery circuit 514 can thus be quickly increased when the sustain pulse falls in period T2A by the reverse energy stored in inductor L10b in period T1A, and the sustain pulse can be made to drop quickly. In addition, the peak current flowing to inductor L10a can be suppressed.

In the following period T3A, the power recovery circuit 614 is driven to supply power from the recovery capacitor C10 to the sustain electrodes SU1 to SUn. Note that switching element Q11A is turned on before time t3A at a time t21A so that the current JL10a produced by the negative energy stored in inductor L10a flows quickly to the inductor L10aA at the transition from period T2A to period T3A.

### Period T3A

At time t3A, switching element Q12 and switching element Q14A turn off and switching element Q14 turns on.

Because the recovery inductor L10aA and interelectrode capacitance Cp form a LC resonance circuit, this switching operation produces LC resonance. Based on this LC resonance, the primary current flows and primary power is supplied from the recovery capacitor C10 passed the inductor L10aA, switching element Q11A, and diode D11A through a forward path to the sustain electrodes SU1 to SUn (FIG. 13B). This primary current is also called the sustain electrode side primary current, the path RB through which the sustain electrode side primary current flows is the path supplying primary power to the sustain electrode side, and is also called the sustain electrode side supply path. As a result, the potential of the sustain electrode drive signal S44 begins to rise at the sustain electrodes SU1 to SUn.

As a result of switching element Q12 turning off at time t3A, the current JL10a flowing through the scan electrode side recovery path is interrupted as shown in FIG. 14. Immediately before the current JL10a is interrupted, the current sum of the negative secondary auxiliary current resulting from the discharge of the stored negative secondary energy and the negative primary current from the scan electrodes SC1 to SCn still flows to the recovery inductor L10a. More specifically, the recovery inductor L10a is charged and energy remains. At time t3A, inductor L10a stops charging energy in reverse and starts discharging. Because the path through inductor L10b and inductor L10a is closed, discharge starts on the path through inductor L10aA, and auxiliary current based on the remaining stored energy flows at inductor L10aA. This auxiliary current produced in period T3A by the sum of the secondary auxiliary current in period T2A and the primary current is also called a tertiary auxiliary current, and the energy that produces this tertiary auxiliary current is also called tertiary auxiliary energy. There is no actual change in the auxiliary energy stored in inductor L10a and inductor L10aA before and after time t3A.

As a result, the tertiary auxiliary current flowing through inductor L10a is thus substantially equal to the current JL10a flowing through the inductor L10a immediately before being cut off multiplied by the turn ratio of the inductor L10a to the inductor L10aA. The inductor L10a and inductor L10aA are rendered with the coils winding in the same direction centering on the recovery capacitor C10. In other words, the coils of inductor L10a and inductor L10aA are wound in the same direction around magnetic core L10z. As a result, the negative energy stored in inductor L10a is converted to positive energy in inductor L10aA. As a result of the forward discharge resulting from the positive energy stored in inductor L10aA, tertiary auxiliary current begins to flow after time t3A from the recovery capacitor C10 passed inductor L10aA, switching element Q11A, and diode D11A along a forward path to the sustain electrodes SU1 to SUn. This path of tertiary auxiliary current flow is also called the sustain electrode side supply discharge path. This tertiary auxiliary current is added to the sustain electrode side primary current that flows as a result of the LC resonance of the recovery inductor L10aA and interelectrode capacitance Cp, and the current JL10a rises rapidly forward. The sustain electrode side supply discharge path is the same as the sustain electrode side supply path.

As a result, the rise in current JL10aA flowing to the sustain electrodes SU1 to SUn is significantly sharper than only the primary current (not shown in the figure) resulting from the LC resonance of the recovery inductor L10aA and interelectrode capacitance Cp as indicated by the waveform showing the change in current JL10aA flowing to the inductor L10aA in FIG. 14.

Current flow from the power recovery circuit 614 to the sustain electrodes SU1 to SUn can thus be quickly increased when the sustain pulse rises in period T3A using the negative energy stored in inductor L10a in period T2A, and the rise in the sustain pulse can be accelerated. In addition, the peak current flowing to inductor L10aA can be suppressed.

The operation from the fall in the sustain pulse of the sustain electrodes SU1 to SUn to the rise in the sustain pulse of the scan electrodes SC1 to SCn (periods T1B, T2B, T3B in FIG. 14) can be described in the same way. More specifically, in period T2B, the sustain electrode side primary current and secondary auxiliary current flow from sustain electrodes SU1 to SUn through diode D12A, switching element Q12A, and inductor L10aA along a path to the recovery capacitor C10 (FIG. 13C). This path RC is also called the sustain electrode side recovery path because sustain electrode side primary current flows, and is also called the sustain electrode side recovery discharge path because secondary auxiliary current flows. The secondary auxiliary current in period T2B is based on the negative primary auxiliary current in period T1B.

In the following period T3B, scan electrode side primary current and tertiary auxiliary current flows from the recovery capacitor C10 through inductor L10a, switching element Q11, and diode D11 on a forward path to the scan electrodes SC1 to SCn (FIG. 13D). This path RD is also called the scan electrode side supply path because scan electrode side primary current flows, and is also called the scan electrode side supply discharge path because tertiary auxiliary current flows.

The tertiary auxiliary current in period T3B is based on the energy remaining in the inductor L10aA due to the current sum of the scan electrode side primary current and secondary auxiliary current in period T2B. The detailed operation in periods T1B to T3B is the same as the operation in periods T1A to T3A, and further description thereof is thus omitted.

Note that in the fifth embodiment as shown in FIG. 14 the sustain electrode drive signal S44 rises after the scan electrode drive signal S43 falls, and the scan electrode drive signal S43 rises after the sustain electrode drive signal S44 falls. Alternatively, however, a configuration in which the scan electrode drive signal S43 falls after the sustain electrode drive signal S44 rises, and the sustain electrode drive signal S44 falls after the scan electrode drive signal S43 rises, is also conceivable. In this configuration the frequency of the sustain pulse is 100 kHz, the rising and falling periods of the sustain pulse are both 1 μsec, and the sustain pulse is clamped to potential Vs for 5 μsec. The duty ratio of the sustain pulse is thus approximately (1+5)/10.60. In addition, the mutual inductor L10C shown in FIG. 13A to FIG. 13D is changed so that the coil of the recovery inductor L10a is wound in the same direction as the coil of the auxiliary inductor L10b, and the coil of the recovery inductor L10aA is wound in the same direction.

As described above, the recovery capacitor C10 charges and discharges scan electrode side primary current and sustain electrode side primary current.

Inductor L10b charges auxiliary power immediately before recovering scan electrode side primary current starts, and when recovery of the scan electrode side primary current starts, inductor L10a discharges the auxiliary power in the recovery direction.

When supplying sustain electrode side primary current starts after scan electrode side primary current is recovered, the inductor L10aA discharges in the supply direction the power that was left in inductor L10a immediately before supplying the sustain electrode side primary current started.

Inductor L10b stores auxiliary power immediately before recovering sustain electrode side primary current starts, and when recovering sustain electrode side primary current starts, inductor L10aA discharges the auxiliary power in the recovery direction.

When supplying scan electrode side primary current starts after recovering the sustain electrode side primary current, inductor L10a discharges in the supply direction the power that remained in the inductor L10aA immediately before supplying scan electrode side primary current started.

By using the auxiliary circuit 534 and mutual inductor L10C in a plasma display device according to the fifth embodiment of the invention, the secondary auxiliary current or tertiary auxiliary current produced by the primary auxiliary energy previously stored in auxiliary inductor L10b can be added to the primary current flow produced by LC resonance at the pulse edges when the sustain pulse rises and falls. As a result, the level of the current flowing between the sustain pulse generating circuit and interelectrode capacitance Cp can be quickly increased. A sufficient sustain pulse clamping period can therefore be assured when the sustain pulse period is shortened due to increased panel definition, and the peak current flowing between the inductor and interelectrode capacitance Cp can be reduced by increasing the resonance period of the recovery inductor and interelectrode capacitance Cp. Therefore, a stable sustain discharge can be produced by assuring a sufficient clamping period, and power consumption and EMI can be reduced by reducing the peak current, in a high definition panel.

In addition, because the recovery capacitor, recovery inductor, and auxiliary circuit can be shared, the parts count can be significantly reduced compared with the first to fourth embodiments.

### Embodiment 6

A sixth embodiment of the invention is described next with particular attention to how it differs from the first to fifth embodiments. Other aspects of the configuration, operation, and effect of this embodiment are identical to the first to fifth embodiments, and further description thereof is omitted.

In the first to fifth embodiments the potential Vs of power source VS2 or the potential VB (=Vs/2) of the recovery capacitor C10 on the high voltage side is used as the power supply potential of the auxiliary circuit, and the ground potential is used as the reference potential of the reference terminal GND2 on the low voltage side. The sixth embodiment of the invention describes a configuration in which the potential Vs of the power source VS2 in the fourth embodiment, and the reference potential of the reference power source GND2 in the first to fifth embodiments, are variable.

The configuration of the fourth embodiment is changed in this sixth embodiment so that a node between the inductor L10b and inductor L10c is connected to power source VS2 through an additional switching element instead of being connected to inductor L10a, and is connected to reference power source GND2 through another additional switching element.

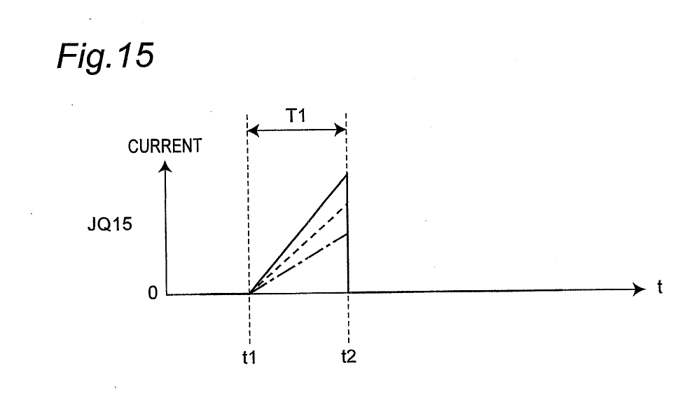

FIG. 15 is a waveform diagram showing for a configuration in which the reference potential of the auxiliary circuit is variable. For example, in the operation that stores primary auxiliary energy forward to inductor L10a in the first to fifth embodiments, the increase per time unit (the slope representing the current rise) in the current JQ15 flowing from the recovery capacitor C10 or power source VS2 through the inductor L10a and forward auxiliary switch (such as switching element Q15) to the reference power source GND2 can be increased by lowering the reference potential, and the rise in current JQ15 can conversely be decreased as indicated by the dotted line or dot-dash line by increasing the reference potential. Furthermore, while not shown in the figure, the same applies to the potential Vs of power source VS2 in the fourth embodiment, and the same effect can be achieved by rendering the potential Vs variable.

Therefore, a configuration for controlling the reference potential of the auxiliary circuit (or the potential Vs of power source VS2) according to the image to be displayed may be provided. One exemplary configuration may lower the reference potential (or increase the potential Vs of the power source VS2) when the display image is bright, or when the on ratio, which is the ratio of discharge cells that emit to the total number of discharge cells, is high. Alternatively, when the display image is dark, or the on ratio is low, the reference potential is increased (or the power supply potential Vs is decreased). This configuration enables further improving display image quality.

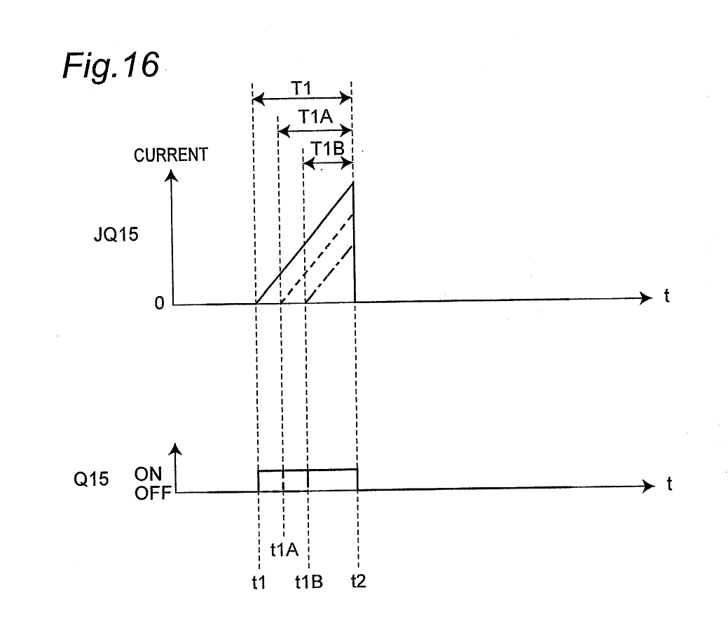

A configuration in which, for example, the energizing period (period T1 and period T4 in FIG. 7) of the forward auxiliary switch (switching element Q15) and the reverse auxiliary switch (switching element Q16) is adjustable in the first to fifth embodiments is described next. FIG. 16 is a waveform diagram for a configuration in which the energizing period of the forward auxiliary switch is variable.

For example, in the operation storing primary auxiliary energy forward to the inductor L10a in the first to fifth embodiments, the amount of forward current JQ15 flowing to the inductor L10a can be increased as indicated by the solid line in FIG. 16 by increasing the energizing period of the forward auxiliary switch as indicated by period T1. Conversely, by shortening the energizing period of the forward auxiliary switch as indicated by period T1A and period T1B in FIG. 16, the amount of current JQ15 flowing forward to the inductor L10a can be reduced as indicated by the dotted and dot-dash lines in the figure. Furthermore, while not shown in the figures, the same applies to current in the negative direction, and the same effect can be achieved by rendering the energizing period of the reverse auxiliary switch variable.

Therefore, a configuration for controlling the energizing period of the forward auxiliary switch and reverse auxiliary switch of the auxiliary circuit according to the displayed image, for example, may also be provided. For example, image display quality can be improved by a configuration that increases the energizing period of the forward auxiliary switch and reverse auxiliary switch when the display image is bright or the on ratio is high, or by shortening the energizing period when the display image is dark or the on ratio is low.

By using an auxiliary circuit or mutual inductor in a plasma display device according to a preferred embodiment of the invention, the secondary auxiliary current or tertiary auxiliary current produced by the primary auxiliary energy previously stored in an auxiliary induction unit can be added to the primary current flow produced by LC resonance at the pulse edges when the sustain pulse rises and falls. As a result, the level of the current flowing between the sustain pulse generating circuit and interelectrode capacitance Cp can be quickly increased. A sufficient sustain pulse clamping period can therefore be assured when the sustain pulse period is shortened due to increased panel definition, and the peak current flowing between the inductor and interelectrode capacitance Cp can be reduced by increasing the resonance period of the recovery inductor and interelectrode capacitance Cp. Therefore, a stable sustain discharge can be produced by assuring a sufficient clamping period, and power consumption and EMI can be reduced by reducing the peak current, in a high definition panel.

Note that embodiments 1, 2, 4, and 5 describe configurations that use the same inductor L10a or L10aA in the power recovery circuit when recovering power and when supplying power. Embodiment 3 describes a configuration that uses two inductors instead of the one inductor L10a used in the first embodiment, or more specifically uses inductor L10a when supplying power from the capacitor C10 to the scan electrodes SC1 to SCn, and uses inductor L20a when recovering power from the scan electrodes SC1 to SCn to the capacitor C10. Embodiments 1, 2, 4, and 5, however, may also be configured so that inductor L10a or L10aA is separated into an inductor for power supply and an inductor for power recovery as in the third embodiment. This configuration enables changing the resonance period when recovering power from the display electrode pairs 24 and when supplying power to the display electrode pairs 24.

It should be noted that the specific numeric values used in the foregoing embodiments of the invention were set based on a 50-inch panel with 1080 display electrode pairs, and simply refer to an example of one preferred embodiment of the invention. The invention is not limited to these values, and the values may be optimized for the characteristics of a specific panel or the specifications of the plasma display device, for example. Note, further, that the foregoing values allow for deviation within the range achieving the effects described above.

The invention was conceived with consideration for the foregoing problems, and can be beneficially used to reduce power consumption and achieve a stable sustain discharge in a plasma display device and a drive method for a plasma display panel even when the panel is a high definition display panel.

The invention may also be described by the variations shown below.

### Variation 1

A plasma display device comprising a sustain pulse generating circuit that alternately applies sustain pulses in a sustain period of a subfield having an initialization period, an address period, and the sustain period to display electrode pairs of a plasma display panel that has a plurality of scan electrodes and sustain electrodes forming the display electrode pairs, wherein:

the sustain pulse generating circuit includes
a power recovery circuit that has a recovery inductor for LC resonance, a recovery capacitor for power recovery, a power recovery path, and a power supply path, recovers power stored in a capacitive load of the display electrode pairs to the recovery capacitor through the power recovery path by LC resonance, and reuses the recovered power to drive the display electrode pairs through the power supply path, and
an auxiliary circuit that has a first auxiliary switch;

the auxiliary circuit is configured to energize the first auxiliary switch and to store energy to the recovery inductor before driving the capacitive load through the power supply path, and energizes the first auxiliary switch and stores energy to the recovery inductor before the sustain pulse rises; and

the power recovery circuit adds current produced by the energy previously stored in the recovery inductor to current produced by the LC resonance to produce the current that flows between the power recovery circuit and the capacitive load when the sustain pulse rises.

### Variation 2

The plasma display device described in variation 1, wherein:

the auxiliary circuit has a second auxiliary switch, and
is configured to energize the second auxiliary switch and to store energy to the recovery inductor before recovering power to the recovery capacitor through the power recovery path, and energizes the second auxiliary switch and stores energy to the recovery inductor before the sustain pulse falls; and

the power recovery circuit adds current produced by the energy previously stored in the recovery inductor to current produced by the LC resonance to produce the current that flows between the power recovery circuit and the capacitive load when the sustain pulse falls.

### Variation 3

The plasma display device described in variation 1, wherein:

the auxiliary circuit is configured to energize the first auxiliary switch and to store energy to the recovery inductor before recovering power to the recovery capacitor through the power recovery path, and energizes the first auxiliary switch and stores energy to the recovery inductor before the sustain pulse falls; and

the power recovery circuit adds current produced by the energy previously stored in the recovery inductor to current produced by the LC resonance to produce the current that flows between the power recovery circuit and the capacitive load when the sustain pulse falls.

### Variation 4

A plasma display device that drives a capacitive load using primary power and auxiliary power, and has

a primary capacitance unit that can store and discharge the primary power;

an auxiliary induction unit that can store the auxiliary power;

a primary induction unit that is coupled by mutual induction to the auxiliary induction unit, can store and discharge the auxiliary power from the auxiliary induction unit, and LC resonates with the capacitive load;

a recovery path that recovers the primary power from the capacitive load through the primary induction unit to the primary capacitance unit based on the LC resonance;

a supply path that supplies the recovered primary power from the primary capacitance unit through the primary induction unit to the capacitive load based on the LC resonance;

a recovery charge path that is a path through the auxiliary induction unit and charges the auxiliary power to the auxiliary induction unit in a direction strengthening the primary power recovery operation;

a recovery discharge path that is a path through the primary induction unit and discharges the auxiliary power charged to the primary induction unit in the recovery direction;

a supply charge path that is a path through the auxiliary induction unit and charges the auxiliary power to the auxiliary induction unit in the direction strengthening the primary power supply operation; and

a supply discharge path that is a path through the primary induction unit and discharges the auxiliary power charged to the primary induction unit in the supply direction;

wherein the recovery path is actually separate from the recovery charge path and is actually the same as the recovery discharge path, and

the supply path is actually separate from the supply charge path and is actually the same as the supply discharge path.

### Variation 5

The plasma display device described in variation 4, wherein:

the auxiliary induction unit stores the auxiliary power immediately before recovering the primary power starts, and

the primary induction unit discharges the auxiliary power in the recovery direction when recovering the primary power starts.

### Variation 6

The plasma display device described in variation 4, wherein:

the auxiliary induction unit stores the auxiliary power immediately before supplying the primary power starts, and

the primary induction unit discharges the auxiliary power in the supply direction when supplying the primary power starts.

### Variation 7

The plasma display device described in variation 4, wherein:

the recovery charge path includes a path through a first switch connected to one end of the auxiliary induction unit; and

the auxiliary induction unit charges the auxiliary power in the recovery direction by the first switch being energized before recovering the primary power starts.

### Variation 8

The plasma display device described in variation 7, wherein:

the supply charge path includes a path through a second switch connected to the other end of the auxiliary induction unit; and

the auxiliary induction unit charges the auxiliary power in the supply direction by the second switch being energized before supplying the primary power starts.

### Variation 9

The plasma display device described in variation 7, wherein:

the auxiliary circuit changes the time the first switch is energized according to the display image.

### Variation 10

The plasma display device described in variation 4, wherein:

the recovery charge path and the supply charge path have a path through the primary capacitance unit in common; and

the auxiliary induction unit stores the auxiliary power from the primary capacitance unit.

### Variation 11

The plasma display device described in variation 4, wherein:

the recovery charge path includes a path through a first switch inserted between the primary capacitance unit and one end of the auxiliary induction unit;

the supply charge path includes a path through a second switch inserted between the primary capacitance unit and the other end of the auxiliary induction unit; and

the primary induction unit charges the auxiliary power in the recovery direction when the first switch is energized, and charges the auxiliary power in the supply direction when the second switch is energized.

### Variation 12

The plasma display device described in variation 4, wherein:

the auxiliary induction unit includes a first secondary auxiliary induction unit and a second secondary auxiliary induction unit;

the first secondary auxiliary induction unit is included in the recovery charge path and stores the auxiliary power to charge the primary induction unit in the recovery direction; and

the second secondary auxiliary induction unit is included in the supply charge path and stores the auxiliary power to charge the primary induction unit in the supply direction.

### Variation 13

The plasma display device described in variation 12, wherein:

the primary induction unit includes a first secondary primary induction unit and a second secondary primary induction unit;

the first secondary primary induction unit is included in the recovery discharge path, is coupled by mutual induction to the first secondary auxiliary induction unit, and charges and discharges the auxiliary power in the recovery direction; and

the second secondary primary induction unit is included in the supply discharge path, is coupled by mutual induction to the second secondary auxiliary induction unit, and charges and discharges the auxiliary power in the supply direction.

### Variation 14

The plasma display device described in variation 4, further comprising:

a path that is a path from a first power source that supplies a first potential to the capacitive load, and holds a preselected electrode of the capacitive load to the first potential by the first power source; and

a path that is a path from the capacitive load to a reference power supply that supplies a reference potential, and holds a preselected electrode of the capacitive load to the reference potential by the reference power supply.

### Variation 15

The plasma display device described in claim 14, wherein:

the auxiliary induction unit includes a first secondary auxiliary induction unit and a second secondary auxiliary induction unit;

the first secondary auxiliary induction unit is inserted between the first power source and the reference power supply, and stores the auxiliary power from the first power source to charge the primary induction unit in the recovery direction; and

the second secondary auxiliary induction unit is inserted between a second power source that supplies a second potential and the reference power supply, and stores the auxiliary power from the second power source to charge the primary induction unit in the supply direction.

### Variation 16

The plasma display device described in variation 15, wherein:

the auxiliary circuit changes the second potential or the reference potential according to the display image.

### Variation 17

The plasma display device described in variation 14, wherein:

the primary capacitance unit can store and discharge first-electrode-side primary power and second-electrode-side primary power;

the recovery path includes a first-electrode-side recovery path that recovers first-electrode-side primary power from a first electrode of the capacitive load, and
a second-electrode-side recovery path that recovers second-electrode-side primary power from a second electrode of the capacitive load; and

the supply path includes a first-electrode-side supply path that supplies the first-electrode-side primary power to a first electrode of the capacitive load, and
a second-electrode-side supply path that supplies the second-electrode-side primary power to a second electrode of the capacitive load.

### Variation 18

The plasma display device described in variation 17, wherein:

the primary induction unit includes a first-electrode-side primary induction unit and a second-electrode-side primary induction unit;

the first-electrode-side primary induction unit and the second-electrode-side primary induction unit are coupled together by negative mutual induction;

the auxiliary induction unit is coupled to the first-electrode-side primary induction unit by negative mutual induction, and is coupled to the second-electrode-side primary induction unit by positive mutual induction;

the first-electrode-side recovery path and the first-electrode-side supply path include a path through the first-electrode-side primary induction unit; and

the second-electrode-side recovery path and the second-electrode-side supply path include a path through the second-electrode-side primary induction unit.

### Variation 19

The plasma display device described in variation 18, wherein:

the auxiliary induction unit stores the auxiliary power immediately before recovering the first-electrode-side primary power starts; and

the first-electrode-side primary induction unit discharges the auxiliary power in the recovery direction when recovering the first-electrode-side primary power starts.

### Variation 20

The plasma display device described in variation 19, wherein:

when supplying the second-electrode-side primary power starts after recovering the first-electrode-side primary power, the second-electrode-side primary induction unit discharges in the supply direction the power remaining in the first-electrode-side primary induction unit immediately before supplying the second-electrode-side primary power starts.

### Variation 21

The plasma display device described in variation 18, wherein:

the auxiliary induction unit stores the auxiliary power immediately before recovering the second-electrode-side primary power starts; and

the second-electrode-side primary induction unit discharges the auxiliary power in the recovery direction when recovering the second-electrode-side primary power starts.

### Variation 22

The plasma display device described in variation 21, wherein:

when supplying the first-electrode-side primary power starts after recovering the second-electrode-side primary power, the first-electrode-side primary induction unit discharges in the supply direction the power remaining in the second-electrode-side primary induction unit immediately before supplying the first-electrode-side primary power starts.

### Variation 23

A plasma display panel that drives a capacitive load using primary power and auxiliary power, comprising:

a power feedback circuit that includes a primary induction unit and a primary capacitance unit that can store and discharge the primary power,
recovers the primary power from the capacitive load through the primary induction unit to the primary capacitance unit based on LC resonance of the capacitive load and the primary induction unit, and
supplies the recovered primary power from the primary capacitance unit through the primary induction unit to the capacitive load; and

an auxiliary circuit including an auxiliary induction unit that can store and discharge the auxiliary power;

wherein the power feedback circuit adds the auxiliary power to the primary power and accelerates the primary power recovery operation and supply operation as a result of the primary induction unit being coupled by mutual induction to the auxiliary induction unit and storing and discharging the auxiliary power from the auxiliary induction unit.

### Variation 24

The plasma display device described in variation 23, wherein:

the auxiliary circuit stores the auxiliary power in the auxiliary induction unit immediately before recovering the primary power starts; and

the power feedback circuit discharges the auxiliary power in the primary induction unit in the recovery direction when recovering the primary power starts.

### Variation 25

The plasma display device described in variation 23, wherein:

the auxiliary circuit stores the auxiliary power in the auxiliary induction unit immediately before supplying the primary power starts; and

the power feedback circuit discharges the auxiliary power in the primary induction unit in the supply direction when supplying the primary power starts.

### INDUSTRIAL APPLICATION

The present invention can be used in plasma display devices and drive methods for plasma display panels.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1-23. (canceled)

24. A plasma display, comprising:
a sustain pulse generating circuit configured to alternately apply sustain pulses in a sustain period of a subfield to drive display electrode pairs of a plasma display panel, the sustain pulse generating circuit including:
a power recovery circuit that includes a recovery inductor having at least two coils and a recovery capacitor the power recovery circuit being configured to recover power stored in a capacitive load of the display electrode pairs and to store the recovered power in the recovery capacitor by LC resonance and to drive the display electrode pairs with the recovered power;
a clamping circuit that clamps the display electrode pairs to a power supply potential and a ground potential, the display electrode pairs comprising a plurality of scan electrodes and a plurality of sustain electrodes; and
an auxiliary circuit that includes a first auxiliary switch and a second auxiliary switch, the auxiliary circuit being configured to store energy in a forward direction to the recovery inductor when the first auxiliary switch is energized, to store energy in a reverse direction to the recovery inductor when the second auxiliary switch is energized, to energize the first auxiliary switch and store energy in the forward direction to the recovery inductor before a sustain pulse rises, and to energize the second auxiliary switch and store energy in the reverse direction to the recovery inductor before the sustain pulse falls,
wherein the power recovery circuit is configured to add current produced by the energy previously stored in the recovery inductor to current produced by the LC resonance to produce current that flows between the power recovery circuit and the capacitive load when the sustain pulse rises and falls.

25. The plasma display of claim 24, wherein
the first auxiliary switch of the auxiliary circuit passes current through a first coil of the at least two coils of the recovery inductor,
the second auxiliary switch of the auxiliary circuit passes current through a second coil of the at least two coils of the recovery inductor, and
the auxiliary circuit is configured to produce current flowing from the recovery capacitor through the first coil of the recovery inductor to a reference potential when the first auxiliary switch is energized and to produce current flowing from the recovery capacitor through the second coil of the recovery inductor to the reference potential when the second auxiliary switch is energized.

26. The plasma display of claim 24, wherein:
the first auxiliary switch and the second auxiliary switch of the auxiliary circuit each include a pair of switching elements, and
the auxiliary circuit is configured to produce current flowing from the recovery capacitor through the first coil of the recovery inductor to the reference potential when the pair of switching elements of the first auxiliary switch is energized and to produce current flowing through the first coil of the recovery inductor to the reference potential in the reverse direction when the pair of switching elements of the second auxiliary switch is energized.

27. The plasma display of claim 24, wherein:
the recovery inductor of the power recovery circuit includes an inductor configured to flow current in the forward direction to store energy in the forward direction and an inductor configured to flow current in the reverse direction to store energy in the reverse direction.

28. The plasma display of claim 24, wherein:
current flows through a first coil of the recovery inductor when the first auxiliary switch and a ground potential side switch of the clamping circuit are energized, and
current flows through a second coil of the recovery inductor when the second auxiliary switch and a power supply potential side switch of the clamping circuit are energized.

29. The plasma display of claim 24, wherein:
the auxiliary circuit varies the power supply potential and a reference potential in the auxiliary circuit according to a display image.

30. The plasma display of claim 25, wherein:
the auxiliary circuit varies an energizing period of the first auxiliary switch and the second auxiliary switch according to a display image.

31. A plasma display, comprising:
a sustain pulse generating circuit configured to alternately apply sustain pulses in a sustain period of a subfield to drive display electrode pairs of a plasma display panel, the sustain pulse generating circuit including:
a power recovery circuit that includes a recovery inductor having at least three coils and a recovery capacitor, the power recovery circuit being configured to recover power stored in a capacitive load of the display electrode pairs and to store the recovered power in the recovery capacitor by LC resonance and to drive the display electrode pairs with the recovered power;
a clamping circuit that clamps the display electrode pairs to a power supply potential and a ground potential, the display electrode pairs comprising a plurality of scan electrodes and a plurality of sustain electrodes; and
an auxiliary circuit that includes an auxiliary switch, the auxiliary circuit being configured to store energy in a reverse direction to the recovery inductor when the auxiliary switch is energized and to energize the auxiliary switch and store energy in the reverse direction to the recovery inductor before a sustain pulse falls,
wherein the power recovery circuit is configured to add current produced by the energy previously stored in the recovery inductor to current produced by the LC resonance to produce current that flows between the power recovery circuit and the capacitive load when the sustain pulse rises and falls.

32. The plasma display of claim 31, wherein
the sustain pulse generating circuit includes a scan electrode sustain pulse generating circuit and a sustain electrode sustain pulse generating circuit, and
the scan electrode sustain pulse generating circuit shares the recovery inductor for LC resonance and the recovery capacitor of the power recovery circuit with the sustain electrode sustain pulse generating circuit.

33. The plasma display of claim 32, wherein
a first coil of the recovery inductor of the power recovery circuit is connected to the auxiliary switch of the auxiliary circuit,
a second coil of the recovery inductor is a recovery inductor of the scan electrode sustain pulse generating circuit, and
a third coil of the recovery inductor is a recovery inductor of the sustain electrode sustain pulse generating circuit.

34. The plasma display of claim 31, wherein
the auxiliary circuit varies the power supply potential and a reference potential in the auxiliary circuit according to a display image.

35. The plasma display of claim 34, wherein
the auxiliary circuit varies an energizing period of the first auxiliary switch and the second auxiliary switch according to the display image.

36. A method for driving a plasma display panel to alternately apply sustain pulses in a sustain period of a subfield to drive display electrode pairs of the plasma display panel, the method comprising:
storing energy in a forward direction to a recovery inductor of a power recovery circuit when a first auxiliary switch of an auxiliary circuit is energized, the recovery inductor having at least two coils;
storing energy in a reverse direction to the recovery inductor of the power recovery circuit when a second auxiliary switch of the auxiliary circuit is energized;
energizing the first auxiliary switch of the auxiliary circuit and storing energy in the forward direction to the recovery inductor of the power recovery circuit before a sustain pulse rises;
energizing the second auxiliary switch of the auxiliary circuit and storing energy in the reverse direction to the recovery inductor of the power recovery circuit before the sustain pulse falls; and
adding current produced by energy previously stored in the recovery inductor of the power recovery circuit to current produced by recovered power stored in a recovery capacitor of the power recovery circuit to produce current that flows between the power recovery circuit and a capacitive load of the display electrode pairs when the sustain pulse rises and falls, the recovered power being recovered from power stored in the capacitive load and stored in the recovery capacitor by LC resonance.

37. The method of claim 36, further comprising:
producing current flowing from the recovery capacitor through the first coil of the recovery inductor to a reference potential when the first auxiliary switch is energized; and
producing current flowing from the recovery capacitor through the second coil of the recovery inductor to the reference potential when the second auxiliary switch is energized.

38. The method of claim 36, wherein a clamping circuit clamps the display electrode pairs to a power supply potential and a ground potential, the method further comprising:
controlling the power supply potential and a reference potential used in the auxiliary circuit according to a display image.

39. The method of claim 36, comprising:
controlling a period that the first auxiliary switch is energized to store energy in the forward direction to the recovery inductor and a period that the second auxiliary switch is energized to store energy in the reverse direction to the recovery inductor, according to a display image.

40. A method for driving a plasma display panel to alternately apply sustain pulses in a sustain period of a subfield to drive display electrode pairs of the plasma display panel, the method comprising:
storing energy in a reverse direction to a recovery inductor of a power recovery circuit when an auxiliary switch of an auxiliary circuit is energized, the recovery inductor having at least three coils;
energizing the auxiliary switch and storing energy in the reverse direction to the recovery inductor before a sustain pulse falls,
storing energy in a reverse direction to the recovery inductor when the auxiliary switch of the auxiliary circuit is energized,
energizing the auxiliary switch and storing energy in the reverse direction to the recovery inductor before the sustain pulse falls, and
adding current produced by energy previously stored in the recovery inductor of the power recovery circuit to current produced by recovered power stored in a recovery capacitor of the power recovery circuit to produce current that flows between the power recovery circuit and a capacitive load of the display electrode pairs when the sustain pulse rises and falls, the recovered power being recovered from power stored in the capacitive load and stored in the recovery capacitor by LC resonance.

41. A device including the plasma display of claim 24.

42. The device of claim 41, wherein the device is a television.

43. The device of claim 41, where the device is a monitor.

44. A device including the plasma display of claim 31.

45. The device of claim 44, wherein the device is a television.

46. The device of claim 44, wherein the device is a monitor.
